(19) United States
(12) Patent Application Publication
(10) Pub. No.: US 2026/0292573 A1
(43) Pub. Date: Sep. 24, 2026

(54) MACHINE LEARNING BASED TRAFFIC DETECTION IN A MOBILE SYSTEM

(71) Applicant: INTEL CORPORATION, Santa Clara, CA (US)

(72) Inventors: Alexandre Saso STOJANOVSKI, Paris (FR); Zongrui DING, Portland, OR (US); Meghashree Dattatri KEDALAGUDDE, Portland, OR (US); Thomas LUETZENKIRCHEN, Taufkirchen (DE); Qian LI, Portland, OR (US)

(73) Assignee: INTEL CORPORATION, Santa Clara, CA (US)

(21) Appl. No.: 19/474,874

(22) PCT Filed: May 7, 2024
(86) PCT No.: PCT/US2024/028182

§ 371 Date: Oct. 13, 2025

Related U.S. Application Data
(60) Provisional application No. 63/501,813, filed on May 12, 2023.

(51) Int. Cl. H04W 24/10; H04L 41/14; H04L 47/2441; H04W 28/10

(52) U.S. Cl. CPC H04W 24/10; H04L 41/14; H04L 47/2441; H04W 28/10

(57) ABSTRACT

This disclosure describes systems, methods, and devices related to ML-based traffic detection. A device may receive a Policy Control and Charging (PCC) rule from a Policy Control Function (PCF), which includes an identifier (ID) for a standardized traffic pattern (STP) and a machine learning model identifier (ML model ID) of an ML model to be used for traffic detection. The device may send a Packet Detection Rule (PDR) to a User Plane Function (UPF) that includes an STP ID and the ML model ID to initiate an ML based detection of the STP.

### CROSS-REFERENCE TO RELATED PATENT APPLICATION(S)

This application claims the benefit of U.S. Provisional Application No. 63/501,813, filed May 12, 2023, the disclosure of which is incorporated herein by reference as if set forth in full.

### TECHNICAL FIELD

This disclosure generally relates to systems and methods for wireless communications and, more particularly, to machine learning based traffic detection in a mobile system.

### BACKGROUND

Wireless devices are becoming widely prevalent and are increasingly requesting access to wireless channels. Open RAN Alliance (O-RAN) is committed to evolve radio access networks. The O-RAN will be deployed based on 3GPP defined network slicing technologies.

### BRIEF DESCRIPTION OF THE DRAWINGS

FIG. 1 depicts an illustrative schematic diagram for 5G system (5GS) architecture.

FIG. 2 depicts an illustrative schematic diagram for machine learning (ML)-based traffic detection, in accordance with one or more example embodiments of the present disclosure.

FIG. 3 illustrates a flow diagram of illustrative process for an illustrative ML-based traffic detection system, in accordance with one or more example embodiments of the present disclosure.

FIG. 4 illustrates an example network architecture, in accordance with one or more example embodiments of the present disclosure.

FIG. 5 schematically illustrates a wireless network, in accordance with one or more example embodiments of the present disclosure.

FIG. 6 illustrates components of a computing device, in accordance with one or more example embodiments of the present disclosure.

FIG. 7 illustrates a network in accordance with various embodiments.

FIG. 8 illustrates a simplified block diagram of artificial (AI)-assisted communication between a user equipment (UE) and a radio access network (RAN), in accordance with various embodiments.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

The packet detection functionality, integral to the proprietary technology of a user plane function (UPF) manufacturer, employs various deep packet inspection techniques, such as heuristic algorithms, to identify packet streams associated with specific applications. The current 3rd Generation Partnership Project (3GPP) specifications permit customers to select application detection filters through application identifiers, yet the exact configurations of these filters remain undisclosed. During session establishment, the session management function (SMF) not only supplies the packet detection rule (PDR) for traffic identification but also issues the forwarding action rule (FAR), which dictates the handling of identified service data flows (SDFs). Conventionally, FAR directs the UPF to route these flows towards predefined quality of service (QoS) paths, with some paths designated for superior QoS management compared to the default best-effort streams.

This mechanism, however, is limited to downlink traffic from the UPF to the user equipment (UE). To achieve symmetric handling in the uplink, additional instructions are necessary for the UE. The SMF can establish a usage reporting rule that prompts the UPF to report back when specific detection criteria are met. Such criteria include the detection of application traffic, at which point the UPF reports the flow details—source and destination IP addresses, port numbers, and protocol IDs—to the SMF. Upon receiving this data, the SMF engages the PCF to make informed decisions about the SDFs.

The uplink handling by the UE requires mirroring the IP 5-tuple information from downlink detection-swapping source and destination parameters—to ensure consistent flow descriptions in both directions. This setup necessitates two primary conditions: detectable service data flows must be describable via an IP 5-tuple, and the uplink SDF description should mirror its downlink counterpart. However, this may not always be feasible, highlighting the need for innovative solutions. Additionally, the existing system involves considerable signaling overhead, suggesting the potential for more signaling-efficient methodologies. Previous solutions have explored concepts like reflective QoS with limited scope, which are not part of current 3GPP standards but have been implemented in certain scenarios.

The “IP 5-tuple” refers to the five parameters that uniquely identify an IP packet flow: the source IP address, destination IP address, source port number, destination port number, and protocol (TCP/UDP). Together these five values in the IP packet header make up the “IP 5-tuple” that allows network functions like the UPF to perform deep packet inspection and match/detect specific network traffic flows based on rules or filters that specify values for each of these five parameters in the packet header. It provides a way to identify network flows using the key identifying information contained in the IP packet.

Example embodiments of the present disclosure relate to systems, methods, and devices for machine learning based traffic detection in a mobile system.

Embodiments herein may relate to the case of traffic detection and steering towards pre-established quality of service (QoS) flows, and may relate to a way to address the asymmetric QoS treatment in uplink and downlink. Embodiments may also relate to the use of machine learning (ML) models for the detection of specific traffic patterns and may include system enhancements for support of ML-based traffic detection. One alternative embodiment may relate to the use of reflective QoS with reduced scope.

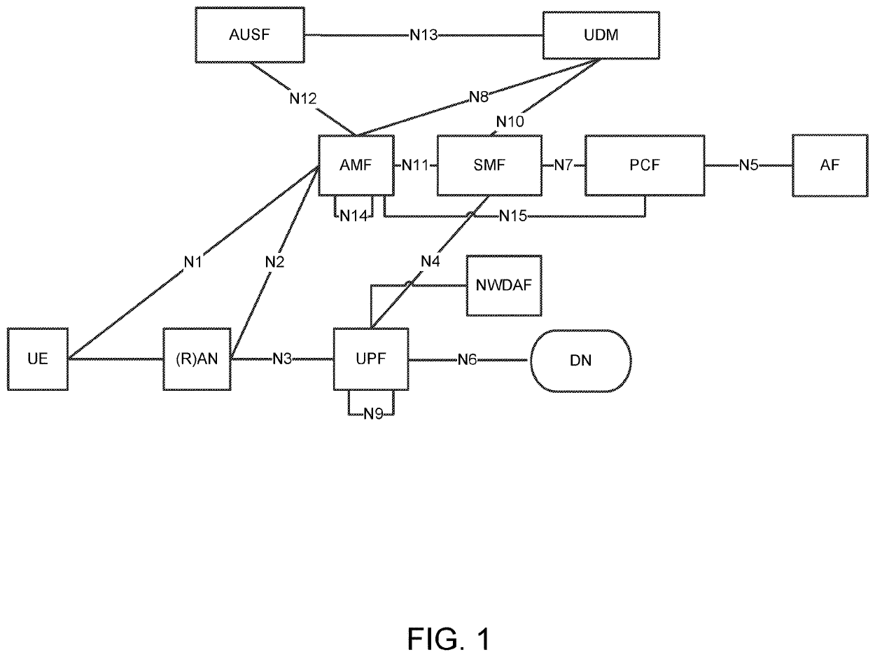

Based on a PCF request, the SMF may instruct both the UPF (via interface N4 (FIG. 1)) and the UE (via N1) to perform detection of a Standardized Traffic Pattern (STP) using a trained machine learning model (ML model) identified via a unique ML model identification (ID). The UPF and the UE can download the ML model from a server in the network if they do not have it stored locally.

In one or more embodiments, an ML-based traffic detection system may comprise a management function (e.g., an SMF or other functions) for managing traffic in a 5G system (5GS), the management function may receive a policy rule (e.g., Policy Control and Charging (PCC) rule or another rule) from a policy function (e.g., a Policy Control Function (PCF) or other function), which includes an identifier (ID) for a standardized traffic pattern (STP) and a machine learning model identifier (ML model ID) of an ML model to be used for traffic detection.

In one or more embodiments, the ML-based traffic detection system may send another rule for packet control (e.g., Packet Detection Rule (PDR)) to a user function (e.g., a User Plane Function (UPF)). This may include a number of IDs (e.g., the STP ID and the ML model ID) to initiate an ML based detection of the STP.

The ML model for the detection of specific traffic patterns is trained by the network data analytics function (NWDAF) model training logical function (MTLF) and provisioned in the NWDAF analytics logical function (AnLF) which derives the STP analytics for the service consumer (e.g., UPF). A new STP analytics may be described herein, which may be identified by an STP Analytics ID. The STP analytics output detected traffic corresponding to the IP 5-tuple that identifies the service flow corresponding to the standardized traffic pattern.

Specific to the UE, the QoS handling for the uplink direction can also be enabled using reflective QoS with reduced scope.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

FIG. 1 depicts an illustrative schematic diagram for 5G system (5GS) architecture.

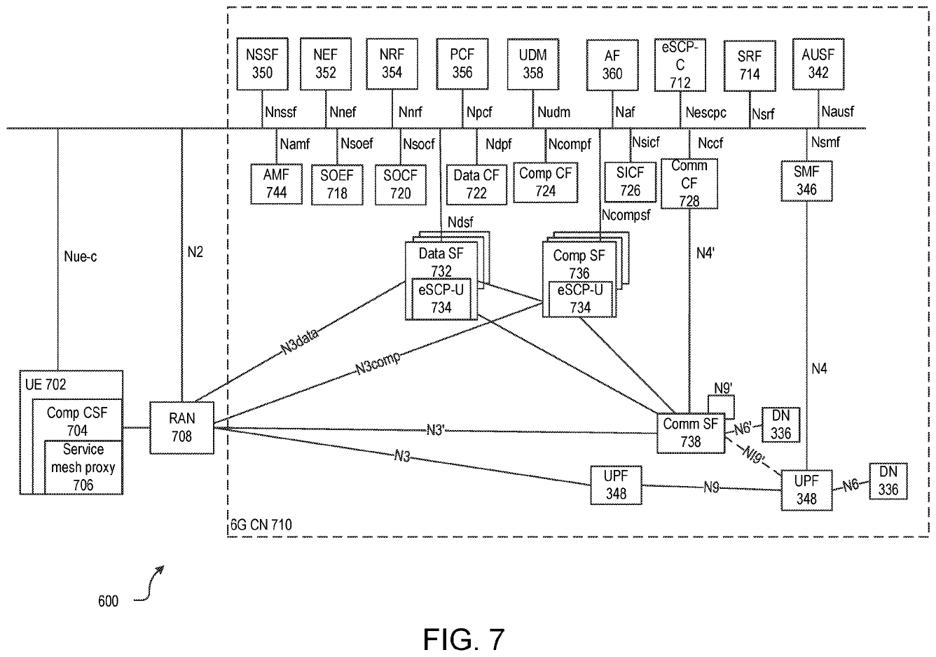

Depicted in FIG. 1 is a simplified 3GPP fifth-generation (5G) system architecture in reference point representation. Such an architecture may be similar to, for example, the architecture depicted in FIG. 7.

The 5G system supports a feature called application detection and control (which may be referred to as ADC) that may be summarized as follows.

The policy control function (PCF) can instruct the session management function (SMF) (and indirectly the user plane function-UPF) to perform detection of service data flows (SDFs) matching specific service data flow filters (SDF filters) or specific application detection filters (AD filters) that the PCF provides to the SMF within a policy control and charging (PCC) rule.

The information included in the PCC rule that the PCF sends to the SMF includes a parameter called Service data flow template that is defined as follows. Such a definition may be similar to, for example, the definition provided in the 3GPP technical specification (TS) 23.502, Table 6.3.1:

| | |
|---|---|
| Service data | For IP PDU traffic: Either a list of service data |
| flow template | flow filters or an application identifier that |
| | references the corresponding application detection |
| | filter for the detection of the service data flow. |
| | For Ethernet PDU traffic: Combination of traffic |
| | patterns of the Ethernet PDU traffic. |
| | It is defined in clause 5.7.6.3 of TS 23.501. |

The service data flow filter may allow the PCF to explicitly designate an SDF by referring to the SDF flow's description e.g. in terms of the IP 5-tuple that describes that SDF. In contrast, the application detection (AD) filter may allow the PCF to invoke a specific packet detection logic in the SMF/UPF that is referenced via an “Application Identifier.” Such an application identifier may be implementation-specific, in some embodiments.

The SMF uses the service data flow template information received in the PCC rule to derive traffic detection information that it forwards over the N4 reference point to the user plane function (UPF) in a packet detection rule (PDR). The PDR may be similar to that defined in 3GPP TS 23.501 clause 5.8.2.4.2 as follows:

For IPV4 or IPV6 or IPv4v6 PDU Session type, detection information is a combination of:

CN tunnel info.
Network instance.
QFI.
IP Packet Filter Set as defined in clause 5.7.6.2.
Application Identifier: The Application Identifier is an index to a set of application detection rules configured in UPF.

The Application Identifier in the PDR references an AD filter in the UPF. The AD filter may be defined in 3GPP TS 23.503 as follows:

Application detection filter: A logic used to detect packets generated by an application based on extended inspection of these packets, e.g. header and/or payload information, as well as dynamics of packet flows. The logic is entirely internal to a UPF and is out of the scope of this specification.

The packet detection logic corresponding to an AD filter may be considered to be a part of the packet detection of the UPF manufacturer and can be based on various Deep Packet Inspection (DPI) techniques (e.g. heuristic algorithms). The 3GPP specifications only allow the SMF to reference over the N4 reference point (via the Application Identifier) a specific AD filter so that the UPF can engage in packet detection targeting specific application traffic when so requested by the SMF.

When the SMF provides the PDR for traffic detection to the UPF, it may also provide a forwarding action rule (FAR) that instructs the UPF on what to do with the detected SDFs. For example, a typical FAR can contain the N3/N9 tunnelling identifiers corresponding to a pre-established QoS Flow allowing the UPF to steer the detected SDFs towards that pre-established QoS Flow.

It is noted that this mechanism for binding SDFs to pre-established QoS Flows based on application traffic detection, as described thus far, may only work in the downlink (UPF to UE) direction. Given that the UE is not instructed for application traffic detection, the UE may bind the corresponding uplink traffic to a different QoS Flow, leading to asymmetry in the QoS treatment received by the traffic in the two directions.

In order to enforce symmetric QoS treatment in both directions, the SMF may proceed as described next.

The SMF may provide a usage reporting rule (URR) to the UPF requesting that it be informed when the UPF has detected specific application traffic via an application detection information parameter which may be similar to that defined in 3GPP TS 29.244 Table 7.5.8.3.2 as follows:

3GPP TS 29.244 Table 7.5.8.3-2: Application Detection Information IE within Usage Report IE

| | Octet 1 and 2 | | | | | | | |
|---|---|---|---|---|---|---|---|---|
| | Application Detection Information IE Type = 68 (decimal) | | | | | | | |
| | Octets 3 and 4 | | | | | | | |
| | Length = n | | | | | | | |
| Information | | | | Appl. | | | | |
| elements | P | Condition/Comment | Sxa | Sxb | Sxc | N4 | N4mb | IE Type |
| Application ID | M | This IE shall identify the Application ID for | — | X | X | X | — | Application |
| | | which a start or stop of traffic is reported. | | | | | | ID |
| Application | C | When present, this IE shall identify the | — | X | X | X | — | Application |
| Instance ID | | Application Instance Identifier for which a | | | | | | Instance ID |
| | | start or stop of traffic is reported. It shall be | | | | | | |
| | | present, when reporting the start of an | | | | | | |
| | | application, if the Reduced Application | | | | | | |
| | | Detection Information flag was not set in the | | | | | | |
| | | Measurement Information and if the flow | | | | | | |
| | | information for the detected application is | | | | | | |
| | | deducible. It shall be present, when reporting | | | | | | |
| | | the stop of an application, if the Reduced | | | | | | |
| | | Application Detection Information flag was | | | | | | |
| | | not set in the Measurement Information and if | | | | | | |
| | | it was provided when reporting the start of the | | | | | | |
| | | application. | | | | | | |
| Flow | C | When present, this IE shall contain the flow | — | X | X | X | — | Flow |
| Information | | information for the detected application. It | | | | | | Information |
| | | shall be present, when reporting the start of an | | | | | | |
| | | application, if the Reduced Application | | | | | | |
| | | Detection Information flag was not set in the | | | | | | |
| | | Measurement Information and if the flow | | | | | | |
| | | information for the detected application is | | | | | | |
| | | deducible. | | | | | | |
| PDR ID | O | When present, it shall contain the PDR ID | — | X | X | X | — | PDR ID |
| | | which the application traffic matches. | | | | | | |

The description of the detected traffic flows (e.g. in terms of IP 5-tuples) may be included in the Flow Information parameter.

Upon reception of the Application Detection Information IE from the UPF, the SMF can request policy update from the PCF. The policy update request includes the AppDetectionInfo parameter defined in 3GPP TS 29.512 Table 5.6.2.22-1 as follows:

Table 5.6.2.22-1: Definition of type AppDetectionInfo:

| | | | | | |
|---|---|---|---|---|---|
| Attribute | | | | | |
| name | Data type | P | Cardinality | Description | Applicability |

| | | | | |
|---|---|---|---|---|
| appId | String | M | 1 | A reference to the |
| | | | | application detection filter |
| | | | | configured at the UPF and |
| | | | | reported to the NF service |
| | | | | consume. |
| instanceId | String | O | 0 . . . 1 | Identifier dynamically |
| | | | | assigned by UPF and |
| | | | | reported to the NF service |
| | | | | consumer in order to allow |
| | | | | correlation of application |
| | | | | Start and Stop events to the |
| | | | | specific service data flow |
| | | | | description, if service data |
| | | | | flow descriptions are |
| | | | | deducible. |
| sdfDescriptions | array(FlowInformation) | O | 1 . . . N | Contains the detected |
| | | | | service data flow |
| | | | | descriptions if they are |
| | | | | deducible. |
| | | | | When present, it shall only |
| | | | | include the |
| | | | | “flowDescription” and the |
| | | | | “flowDirection” attributes of |
| | | | | the FlowInformation data |
| | | | | type. |

The sdfDescriptions in the AppDetectionInfo parameter (N7) may correspond to the Flow Information in the Application Detection Information parameter (N4).

Based on the received SDF descriptions corresponding to the detected application traffic, the PCF can instruct the SMF on how to handle the detected SDFs. For example, the PCF can request the SMF to establish a new QoS Flow and bind the detected SDFs on the new QoS Flow. The establishment of a new QoS Flow involves the UE, which means that the UE may also receive the description of the detected SDFs as part of a QoS rule.

This scheme may allow for symmetric QoS treatment in the case that one or more of the following example conditions are met: 1) the detected service data flows need to be deducible (e.g. it should be possible to describe them with an IP 5-tuple), and 2) the SDF description in the uplink direction needs to be a mirror of the SDF description of the detected SDF in the downlink direction (i.e. the source and destination address/port numbers in the downlink should correspond to the destination and source address/port numbers in the uplink).

It should be noted that the scheme described above where the PCF is notified about application traffic detection, followed by subsequent QoS Flow establishment, may introduce additional signaling on the N4, N7, and N1 interfaces, which may not be desirable.

NWDAF (Network Data and Analytics Function) AnLF (Analytics Logical Function) is a network function in 5GC that performs inference, derives analytics information (i.e. derives statistics and/or predictions based on Analytics Consumer request) and NWDAF MTLF (Model Training Logical Function) is a network function in the 5G core (5GC) which trains Machine Learning (ML) models.

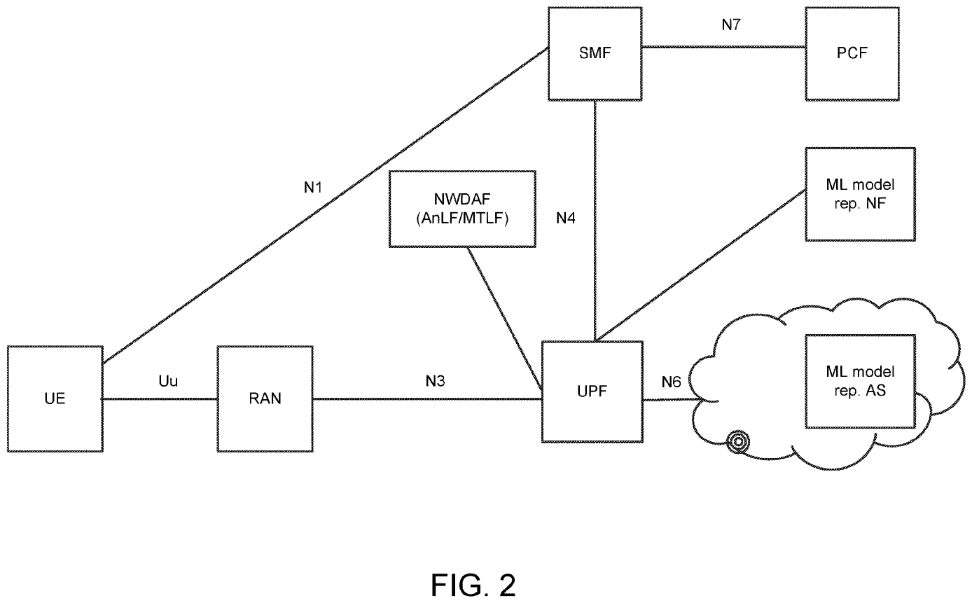

FIG. 2 depicts an illustrative schematic diagram for ML-based traffic detection, in accordance with one or more example embodiments of the present disclosure.

Referring to FIG. 2, there is shown a system architecture for ML-based application traffic detection.

Discussion of embodiments herein may relate to, include, or rely upon one or more of the following example assumptions: 1) it is possible to define standardized traffic patterns (STPs), and 2) machine learning (ML) models trained to detect such STPs are available at the UPF, the UE and the NWDAF AnLF (NWDAF Analytics function).

Listed below are some examples of STP:
voice traffic with 20 millisecond (ms) periodicity.
video traffic with 60 frames per second (fps).
video traffic with 45 fps.
video traffic with 30 fps.
etc.

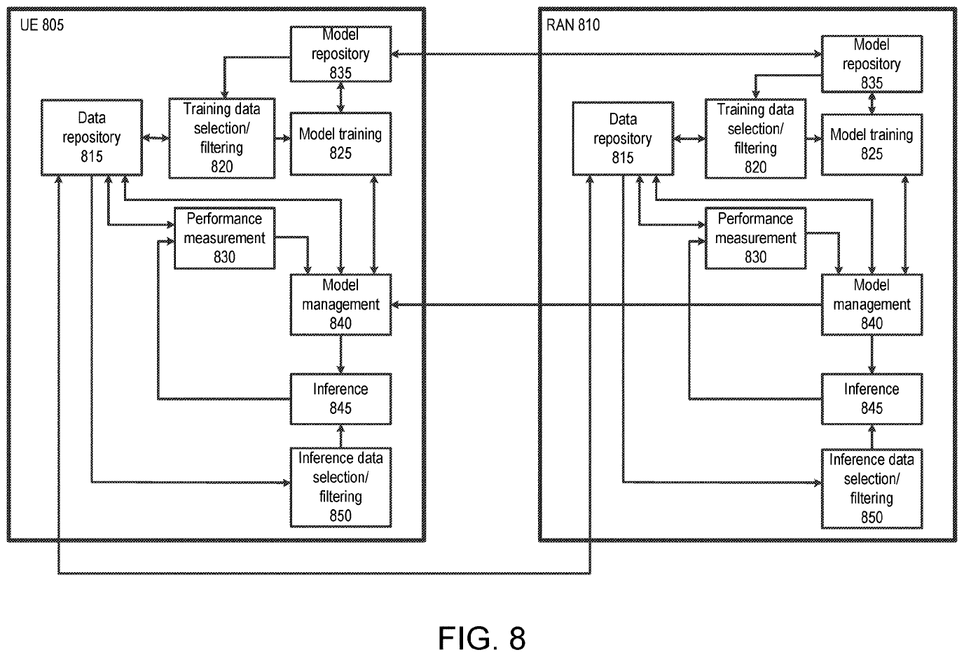

An example system architecture for ML-based application traffic detection is depicted in FIG. 2. Elements of FIG. 2 may be similar to those of, for example, FIG. 8.

In one or more embodiments, an ML-based traffic detection system may facilitate that an ML model is uniquely identified with an ML model identifier (ML model ID) and is trained to detect a specific standardized traffic pattern (STP) identified with an STP identifier (STP ID).

In some embodiments, the ML model ID may be encoded as one of the following:
A well-known name (text string) that uniquely identifies a well-known ML model.
A uniform resource locator (URL) that points to a network location from which the ML model can be fetched.

In some embodiments, a new STP analytics is defined which is identified by an STP Analytics ID. An NWDAF model training logical function (MTLF) provides a trained ML model to the NWDAF AnLF (analytics logic function) identified by an ML model identifier. This trained ML model in NWDAF AnLF provides the STP Analytics when requested by a service consumer (e.g., UPF) which can be used by the consumer to detect a specific STP. The STP analytics output is the IP 5-tuple of the the service flow corresponding to the detected standardized traffic pattern. It is assumed that the NWDAF AnLF is co-located with the UPF for traffic detection.

The UPF can download an ML model identified with the ML model ID from a network function (NF) in the 5G Core Network (e.g., the MF model repository NF in FIG. 2).

In some embodiment, the ML model repository which stores the trained ML model corresponding to the STP Analytics ID is the ML model repository NF (which could be the ADRF defined in TS 23.288). Similarly, the UE can download an ML model identified with the ML model ID from an application server (AS) in the data network (e.g. the MF model repository AS in FIG. 2).

The UE may be provided with the ML model ID of a trained ML model and the URL of a trained ML model (where the trained ML is stored) via a non-access stratum (NAS) message. The trained ML model indicated to the UE may be the same as or different from the trained model indicated to the UPF. In this context, NAS refers to the Non-Access Stratum interface, specifically the N1 reference point between the UE (User Equipment) and the AMF (Access and Mobility Management Function) in the 5G core network. A NAS message refers to signaling messages exchanged over the N1 interface using the NAS protocol. When a trained machine learning model is indicated to the UE via a NAS message, it means that the model information is provided to the UE through signaling transmitted over the N1 reference point between the UE and the 5G core network.

The 5G core network refers to the core network architecture defined by 3GPP to support 5G cellular technology. It consists of key network functions including the access and mobility management function (AMF) which manages access control and mobility as the ingress point for UE signaling, the SMF which handles session management and QoS policies, the UPF which provides user plane functionality like packet routing and filtering, the PCF which provides a unified policy framework and QoS handling, and the UDM which stores and manages subscription and profile data. Together these network functions make up the 5G core, which provides connectivity and services to 5G user equipment in the network while supporting new 5G capabilities like network slicing, ultra-low latency, and usage of mobile edge computing.

The URL may correspond to an ADRF where the trained ML model is stored or an application server in the data network where for example, the application server belongs to a CDN and the operator has an SLA with the CDN to train specific ML models and ‘act’ as a repository of the ML models trained to generate very specific analytics information (in this case STP Analytics).

When PCF wishes to initiate detection of an STP, it forwards a PCC rule to the SMF including the STP ID of that STP, as well as the ML model ID for the ML model to be used for traffic detection.

The SMF instructs the UPF to initiate detection of an STP by sending a PDR (via N4) to the UPF including the STP ID of that STP, as well as the ML model ID for the ML model to be used for traffic detection. If the UPF does not have this ML model stored locally, the UPF fetches the indicated ML model from the network functions that serve as the ML model repository.

In some embodiment, when SMF instructs the UPF to initiate detection of an STP by sending a PDR (via N4) to the UPF including the STP ID of that STP, then the UPF in the role of service consumer subscribes/requests for STP Analytics from an NWDAF AnLF where the STP analytics output is the IP 5-tuple of the service flow corresponding to the detected standardized traffic pattern.

Similarly, the SMF instructs the UE to initiate detection of an STP by sending a Qos rule (via N1) to the UE including the STP ID of that STP, as well as the ML model ID for the ML model, and optionally may include the uniform resource locator (URL) of the trained ML model to be used for traffic detection. In this context, the URL is provided along with a machine learning model ID when a trained ML model is indicated to network elements like the UPF or UE. The URL points to the network location from which the specified ML model can be fetched or retrieved. For example, if a model was stored on an application server in a content distribution network, the URL could specify the exact address to access and download the model file from that server. This allows the URL to reference and direct access to the dynamic network location where the particular ML model is stored, so it can be retrieved as needed by the network elements performing traffic detection tasks based on the model.

The QoS rule contains the QoS flow identifier (QFI) of the QoS flow on which the UE needs to steer the uplink packets of the detected STP. For example, QFI is used to identify a specific QoS flow that has been established between the UE and the UPF. If the UE does not have the indicated ML model stored locally, the UE fetches the indicated ML model from an application server in the data network that serves as an ML model repository or based on the URL of the trained ML model when provided by the network.

It should be noted that the QoS rule today in its simplest form includes the QFI of the associated QoS Flow, a packet filter Set (e.g. an IP 5-tuple), and a precedence value.

In some embodiment, when the SMF is required to initiate detection of an STP (based on the request from PCF via PCC rule) by sending a QoS rule to the UE, the SMF may discover an NWDAF MTLF via the NRF which can provide a trained ML model i.e., ML model ID and

URL of the trained ML model for STP Analytics to the SMF.

In another embodiment, when the PCF wishes to initiate detection of an STP, the PCF may discover an NWDAF MTLF via the NRF which can provide a trained ML model i.e., ML model ID and optionally URL of the trained ML model for STP analytics to the PCF.

Once the UPF detects the targeted STP, the UPF steers the downlink packets of this STP to a pre-established QoS Flow, as indicated in the corresponding forwarding action rule (FAR).

Once the UE detects the targeted STP, the UE steers the uplink packets of this STP to a pre-established QoS flow, as indicated in the QoS rule.

In another alternative embodiment, the STP ID in the PCC rule is subsumed under the existing application ID in the PCC rule (on N7) and the STP ID in the PDR is subsumed under the existing application identifier in the PDR (on N4).

In another embodiment, the STP detection based on ML is performed only in the UPF. To ensure symmetric QoS handling, once the UPF detects a specific STP, it uses reflective Qos with reduced scope towards the UE. Specifically, the UPF marks the downlink packets of this STP with a reflective QoS indicator (RQI). Upon reception of downlink packets marked with RQI, the UE creates UE derived QoS rule with reduced scope (e.g., the UE creates the uplink packet filter by swapping the source and destination IP address received in the downlink packet, while wildcarding the port number fields)

It should be noted that the reflective QoS feature may assume that the creation of packet filters in the UE is based on the “full scope” of the IP 5-tuple. Namely, when the protocol ID/next header field in the downlink packet is set to TCP or UDP, the creation of packet filters for derived QoS rules is scoped on the whole 5-tuple i.e., the source IP address is swapped with the destination IP address, and the source port number is swapped with the destination port number.

In contrast, embodiments herein may assume that UE uses reflective QoS with reduced scope. Namely, when the protocol ID/next header field in the downlink packet is set to TCP or UDP, the creation of packet filters for derived QoS rules is scoped only on the IP address fields i.e., the source IP address is swapped with destination IP address, while the port number in the packet filter is presented as a wildcard value.

It is understood that the above descriptions are for the purposes of illustration and are not meant to be limiting.

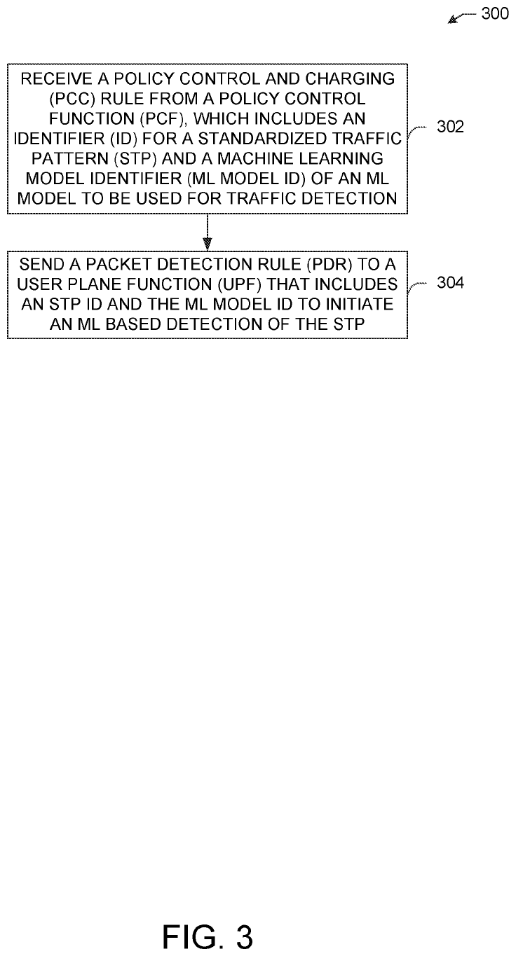

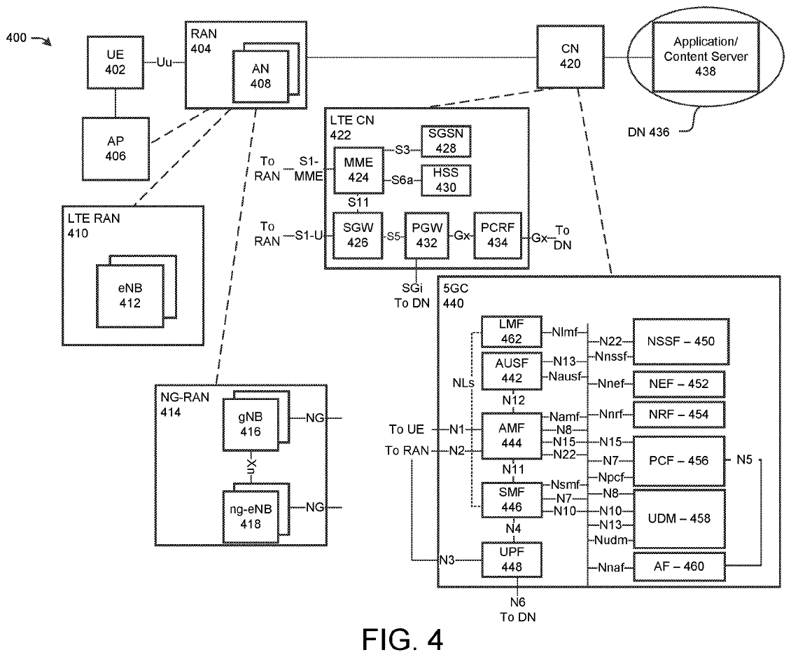

In some embodiments, the electronic device(s), network(s), system(s), chip(s), component(s), or portions or implementations thereof, of FIG. 4-7 or 8, or some other figure herein, may be configured to perform one or more processes, techniques, or methods as described herein, or portions thereof. One such process is depicted in FIG. 3.

For example, the process may include, at 302, receiving a Policy Control and Charging (PCC) rule from a Policy Control Function (PCF), which includes an identifier (ID) for a standardized traffic pattern (STP) and a machine learning model identifier (ML model ID) of an ML model to be used for traffic detection.

The process further includes, at 304 send a Packet Detection Rule (PDR) to a User Plane Function (UPF) that includes an STP ID and the ML model ID to initiate an ML based detection of the STP.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

It is understood that the above descriptions are for purposes of illustration and are not meant to be limiting.

FIG. 4-7 or 8 illustrate various systems, devices, and components that may implement aspects of disclosed embodiments.

FIG. 4 illustrates an example network architecture 400 according to various embodiments. The network 400 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 400 includes a UE 402, which is any mobile or non-mobile computing device designed to communicate with a RAN 404 via an over-the-air connection. The UE 402 is communicatively coupled with the RAN 404 by a Uu interface, which may be applicable to both LTE and NR systems. Examples of the UE 402 include, but are not limited to, a smartphone, tablet computer, wearable computer, desktop computer, laptop computer, in-vehicle infotainment system, in-car entertainment system, instrument cluster, head-up display (HUD) device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, machine-to-machine (M2M), device-to-device (D2D), machine-type communication (MTC) device, Internet of Things (IoT) device, and/or the like. The network 400 may include a plurality of UEs 402 coupled directly with one another via a D2D, ProSe, PC5, and/or sidelink (SL) interface. These UEs 402 may be M2M/D2D/MTC/IoT devices and/or vehicular systems that communicate using physical sidelink channels such as, but not limited to, PSBCH, PSDCH, PSSCH, PSCCH, PSFCH, etc. The UE 402 may perform blind decoding attempts of SL channels/links according to the various embodiments herein.

In some embodiments, the UE 402 may additionally communicate with an AP 406 via an over-the-air (OTA) connection. The AP 406 manages a WLAN connection, which may serve to offload some/all network traffic from the RAN 404. The connection between the UE 402 and the AP 406 may be consistent with any IEEE 802.11 protocol. Additionally, the UE 402, RAN 404, and AP 406 may utilize cellular-WLAN aggregation/integration (e.g., LWA/LWIP). Cellular-WLAN aggregation may involve the UE 402 being configured by the RAN 404 to utilize both cellular radio resources and WLAN resources.

The RAN 404 includes one or more access network nodes (ANs) 408. The ANs 408 terminate air-interface(s) for the UE 402 by providing access stratum protocols including RRC, PDCP, RLC, MAC, and PHY/LI protocols. In this manner, the AN 408 enables data/voice connectivity between CN 420 and the UE 402. The ANs 408 may be a macrocell base station or a low power base station for providing femtocells, picocells or other like cells having smaller coverage areas, smaller user capacity, or higher bandwidth compared to macrocells; or some combination thereof. In these implementations, an AN 408 be referred to as a BS, gNB, RAN node, eNB, ng-eNB, NodeB, RSU, TRxP, etc.

One example implementation is a “CU/DU split” architecture where the ANs 408 are embodied as a gNB-Central Unit (CU) that is communicatively coupled with one or more gNB-Distributed Units (DUs), where each DU may be communicatively coupled with one or more Radio Units (RUs) (also referred to as RRHs, RRUs, or the like) (see e.g., 3GPP TS 38.401 v16.1.0 (2020-03)). In some implementations, the one or more RUs may be individual RSUs. In some implementations, the CU/DU split may include an ng-eNB-CU and one or more ng-eNB-DUs instead of, or in addition to, the gNB-CU and gNB-DUs, respectively. The ANs 408 employed as the CU may be implemented in a discrete device or as one or more software entities running on server computers as part of, for example, a virtual network including a virtual Base Band Unit (BBU) or BBU pool, cloud RAN (CRAN), Radio Equipment Controller (REC), Radio Cloud Center (RCC), centralized RAN (C-RAN), virtualized RAN (vRAN), and/or the like (although these terms may refer to different implementation concepts). Any other type of architectures, arrangements, and/or configurations can be used.

The plurality of ANs may be coupled with one another via an X2 interface (if the RAN 404 is an LTE RAN or Evolved Universal Terrestrial Radio Access Network (E-UTRAN) 410) or an Xn interface (if the RAN 404 is a NG-RAN 414). The X2/Xn interfaces, which may be separated into control/user plane interfaces in some embodiments, may allow the ANs to communicate information related to handovers, data/context transfers, mobility, load management, interference coordination, etc.

The ANs of the RAN 404 may each manage one or more cells, cell groups, component carriers, etc. to provide the UE 402 with an air interface for network access. The UE 402 may be simultaneously connected with a plurality of cells provided by the same or different ANs 408 of the RAN 404. For example, the UE 402 and RAN 404 may use carrier aggregation to allow the UE 402 to connect with a plurality of component carriers, each corresponding to a Pcell or Scell. In dual connectivity scenarios, a first AN 408 may be a master node that provides an MCG and a second AN 408 may be secondary node that provides an SCG. The first/second ANs 408 may be any combination of eNB, gNB, ng-eNB, etc.

The RAN 404 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 402 or AN 408 may be or act as a roadside unit (RSU), which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 404 may be an E-UTRAN 410 with one or more eNBs 412. The an E-UTRAN 410 provides an LTE air interface (Uu) with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 404 may be an next generation (NG)-RAN 414 with one or more gNB 416 and/or on or more ng-eNB 418. The gNB 416 connects with 5G-enabled UEs 402 using a 5G NR interface. The gNB 416 connects with a 5GC 440 through an NG interface, which includes an N2 interface or an N3 interface. The ng-eNB 418 also connects with the 5GC 440 through an NG interface, but may connect with a UE 402 via the Uu interface. The gNB 416 and the ng-eNB 418 may connect with each other over an Xn interface.

In some embodiments, the NG interface may be split into two parts, an NG user plane (NG-U) interface, which carries traffic data between the nodes of the NG-RAN 414 and a UPF 448 (e.g., N3 interface), and an NG control plane (NG-C) interface, which is a signaling interface between the nodes of the NG-RAN 414 and an AMF 444 (e.g., N2 interface).

The NG-RAN 414 may provide a 5G-NR air interface (which may also be referred to as a Uu interface) with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

The 5G-NR air interface may utilize BWPs for various purposes. For example, BWP can be used for dynamic adaptation of the SCS. For example, the UE 402 can be configured with multiple BWPs where each BWP configuration has a different SCS. When a BWP change is indicated to the UE 402, the SCS of the transmission is changed as well. Another use case example of BWP is related to power saving. In particular, multiple BWPs can be configured for the UE 402 with different amount of frequency resources (e.g., PRBs) to support data transmission under different traffic loading scenarios. A BWP containing a smaller number of PRBs can be used for data transmission with small traffic load while allowing power saving at the UE 402 and in some cases at the gNB 416. A BWP containing a larger number of PRBs can be used for scenarios with higher traffic load.

The RAN 404 is communicatively coupled to CN 420 that includes network elements and/or network functions (NFs) to provide various functions to support data and telecommunications services to customers/subscribers (e.g., UE 402). The components of the CN 420 may be implemented in one physical node or separate physical nodes. In some embodiments, NFV may be utilized to virtualize any or all of the functions provided by the network elements of the CN 420 onto physical compute/storage resources in servers, switches, etc. A logical instantiation of the CN 420 may be referred to as a network slice, and a logical instantiation of a portion of the CN 420 may be referred to as a network sub-slice.

The CN 420 may be an LTE CN 422 (also referred to as an Evolved Packet Core (EPC) 422). The EPC 422 may include MME 424, SGW 426, SGSN 428, HSS 430, PGW 432, and PCRF 434 coupled with one another over interfaces (or “reference points”) as shown. The NFs in the EPC 422 are briefly introduced as follows.

The MME 424 implements mobility management functions to track a current location of the UE 402 to facilitate paging, bearer activation/deactivation, handovers, gateway selection, authentication, etc.

The SGW 426 terminates an S1 interface toward the RAN 410 and routes data packets between the RAN 410 and the EPC 422. The SGW 426 may be a local mobility anchor point for inter-RAN node handovers and also may provide an anchor for inter-3GPP mobility. Other responsibilities may include lawful intercept, charging, and some policy enforcement.

The SGSN 428 tracks a location of the UE 402 and performs security functions and access control. The SGSN 428 also performs inter-EPC node signaling for mobility between different RAT networks; PDN and S-GW selection as specified by MME 424; MME 424 selection for handovers; etc. The S3 reference point between the MME 424 and the SGSN 428 enable user and bearer information exchange for inter-3GPP access network mobility in idle/active states.

The HSS 430 includes a database for network users, including subscription-related information to support the network entities' handling of communication sessions. The HSS 430 can provide support for routing/roaming, authentication, authorization, naming/addressing resolution, location dependencies, etc. An S6a reference point between the HSS 430 and the MME 424 may enable transfer of subscription and authentication data for authenticating/authorizing user access to the EPC 420.

The PGW 432 may terminate an SGi interface toward a data network (DN) 436 that may include an application (app)/content server 438. The PGW 432 routes data packets between the EPC 422 and the data network 436. The PGW 432 is communicatively coupled with the SGW 426 by an S5 reference point to facilitate user plane tunneling and tunnel management. The PGW 432 may further include a node for policy enforcement and charging data collection (e.g., PCEF). Additionally, the SGi reference point may communicatively couple the PGW 432 with the same or different data network 436. The PGW 432 may be communicatively coupled with a PCRF 434 via a Gx reference point.

The PCRF 434 is the policy and charging control element of the EPC 422. The PCRF 434 is communicatively coupled to the app/content server 438 to determine appropriate Qos and charging parameters for service flows. The PCRF 432 also provisions associated rules into a PCEF (via Gx reference point) with appropriate TFT and QCI.

The CN 420 may be a 5GC 440 including an AUSF 442, AMF 444, SMF 446, UPF 448, NSSF 450, NEF 452, NRF 454, PCF 456, UDM 458, and AF 460 coupled with one another over various interfaces as shown. The NFs in the 5GC 440 are briefly introduced as follows.

The AUSF 442 stores data for authentication of UE 402 and handle authentication-related functionality. The AUSF 442 may facilitate a common authentication framework for various access types.

The AMF 444 allows other functions of the 5GC 440 to communicate with the UE 402 and the RAN 404 and to subscribe to notifications about mobility events with respect to the UE 402. The AMF 444 is also responsible for registration management (e.g., for registering UE 402), connection management, reachability management, mobility management, lawful interception of AMF-related events, and access authentication and authorization. The AMF 444 provides transport for SM messages between the UE 402 and the SMF 446, and acts as a transparent proxy for routing SM messages. AMF 444 also provides transport for SMS messages between UE 402 and an SMSF. AMF 444 interacts with the AUSF 442 and the UE 402 to perform various security anchor and context management functions. Furthermore, AMF 444 is a termination point of a RAN-CP interface, which includes the N2 reference point between the RAN 404 and the AMF 444. The AMF 444 is also a termination point of NAS (N1) signaling, and performs NAS ciphering and integrity protection.

AMF 444 also supports NAS signaling with the UE 402 over an N3IWF interface. The N3IWF provides access to untrusted entities. N3IWF may be a termination point for the N2 interface between the (R)AN 404 and the AMF 444 for the control plane, and may be a termination point for the N3 reference point between the (R)AN 414 and the 448 for the user plane. As such, the AMF 444 handles N2 signalling from the SMF 446 and the AMF 444 for PDU sessions and QoS, encapsulate/de-encapsulate packets for IPSec and N3 tunnelling, marks N3 user-plane packets in the uplink, and enforces QoS corresponding to N3 packet marking taking into account QoS requirements associated with such marking received over N2. N3IWF may also relay UL and DL control-plane NAS signalling between the UE 402 and AMF 444 via an N1 reference point between the UE 402 and the AMF 444, and relay uplink and downlink user-plane packets between the UE 402 and UPF 448. The N3IWF also provides mechanisms for IPsec tunnel establishment with the UE 402. The AMF 444 may exhibit an Namf service-based interface, and may be a termination point for an N14 reference point between two AMFs 444 and an N17 reference point between the AMF 444 and a 5G-EIR (not shown by FIG. 4).

The SMF 446 is responsible for SM (e.g., session establishment, tunnel management between UPF 448 and AN 408); UE IP address allocation and management (including optional authorization); selection and control of UP function; configuring traffic steering at UPF 448 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 444 over N2 to AN 408; and determining SSC mode of a session. SM refers to management of a PDU session, and a PDU session or “session” refers to a PDU connectivity service that provides or enables the exchange of PDUs between the UE 402 and the DN 436.

The UPF 448 acts as an anchor point for intra-RAT and inter-RAT mobility, an external PDU session point of interconnect to data network 436, and a branching point to support multi-homed PDU session. The UPF 448 also performs packet routing and forwarding, packet inspection, enforces user plane part of policy rules, lawfully intercept packets (UP collection), performs traffic usage reporting, perform QoS handling for a user plane (e.g., packet filtering, gating, UL/DL rate enforcement), performs uplink traffic verification (e.g., SDF-to-QoS flow mapping), transport level packet marking in the uplink and downlink, and performs downlink packet buffering and downlink data notification triggering. UPF 448 may include an uplink classifier to support routing traffic flows to a data network.

The NSSF 450 selects a set of network slice instances serving the UE 402. The NSSF 450 also determines allowed NSSAI and the mapping to the subscribed S-NSSAIs, if needed. The NSSF 450 also determines an AMF set to be used to serve the UE 402, or a list of candidate. AMFs 444 based on a suitable configuration and possibly by querying the NRF 454. The selection of a set of network slice instances for the UE 402 may be triggered by the AMF 444 with which the UE 402 is registered by interacting with the NSSF 450; this may lead to a change of AMF 444. The NSSF 450 interacts with the AMF 444 via an N22 reference point; and may communicate with another NSSF in a visited network via an N31 reference point (not shown).

The NEF 452 securely exposes services and capabilities provided by 3GPP NFs for third party, internal exposure/re-exposure, AFs 460, edge computing or fog computing systems (e.g., edge compute node, etc. In such embodiments, the NEF 452 may authenticate, authorize, or throttle the AFs. NEF 452 may also translate information exchanged with the AF 460 and information exchanged with internal network functions. For example, the NEF 452 may translate between an AF-Service-Identifier and an internal 5GC information. NEF 452 may also receive information from other NFs based on exposed capabilities of other NFs. This information may be stored at the NEF 452 as structured data, or at a data storage NF using standardized interfaces. The stored information can then be re-exposed by the NEF 452 to other NFs and AFs, or used for other purposes such as analytics.

The NRF 454 supports service discovery functions, receives NF discovery requests from NF instances, and provides information of the discovered NF instances to the requesting NF instances. NRF 454 also maintains information of available NF instances and their supported services. The NRF 454 also supports service discovery functions, wherein the NRF 454 receives NF Discovery Request from NF instance or an SCP (not shown), and provides information of the discovered NF instances to the NF instance or SCP.

The PCF 456 provides policy rules to control plane functions to enforce them, and may also support unified policy framework to govern network behavior. The PCF 456 may also implement a front end to access subscription information relevant for policy decisions in a UDR of the UDM 458. In addition to communicating with functions over reference points as shown, the PCF 456 exhibit an Npcf service-based interface.

The UDM 458 handles subscription-related information to support the network entities' handling of communication sessions, and stores subscription data of UE 402. For example, subscription data may be communicated via an N8 reference point between the UDM 458 and the AMF 444. The UDM 458 may include two parts, an application front end and a UDR. The UDR may store subscription data and policy data for the UDM 458 and the PCF 456, and/or structured data for exposure and application data (including PFDs for application detection, application request information for multiple UEs 402) for the NEF 452. The Nudr service-based interface may be exhibited by the UDR 221 to allow the UDM 458, PCF 456, and NEF 452 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 458 may exhibit the Nudm service-based interface.

AF 460 provides application influence on traffic routing, provide access to NEF 452, and interact with the policy framework for policy control. The AF 460 may influence UPF 448 (re) selection and traffic routing. Based on operator deployment, when AF 460 is considered to be a trusted entity, the network operator may permit AF 460 to interact directly with relevant NFs. Additionally, the AF 460 may be used for edge computing implementations,

The 5GC 440 may enable edge computing by selecting operator/3rd party services to be geographically close to a point that the UE 402 is attached to the network. This may reduce latency and load on the network. In edge computing implementations, the 5GC 440 may select a UPF 448 close to the UE 402 and execute traffic steering from the UPF 448 to DN 436 via the N6 interface. This may be based on the UE subscription data, UE location, and information provided by the AF 460, which allows the AF 460 to influence UPF (re)selection and traffic routing.

The data network (DN) 436 may represent various network operator services, Internet access, or third party services that may be provided by one or more servers including, for example, application (app)/content server 438. The DN 436 may be an operator external public, a private PDN, or an intra-operator packet data network, for example, for provision of IMS services. In this embodiment, the app server 438 can be coupled to an IMS via an S-CSCF or the I-CSCF. In some implementations, the DN 436 may represent one or more local area DNs (LADNs), which are DNs 436 (or DN names (DNNs)) that is/are accessible by a UE 402 in one or more specific areas. Outside of these specific areas, the UE 402 is not able to access the LADN/DN 436.

Additionally or alternatively, the DN 436 may be an Edge DN 436, which is a (local) Data Network that supports the architecture for enabling edge applications. In these embodiments, the app server 438 may represent the physical hardware systems/devices providing app server functionality and/or the application software resident in the cloud or at an edge compute node that performs server function(s). In some embodiments, the app/content server 438 provides an edge hosting environment that provides support required for Edge Application Server's execution.

In some embodiments, the 5GS can use one or more edge compute nodes to provide an interface and offload processing of wireless communication traffic. In these embodiments, the edge compute nodes may be included in, or co-located with one or more RAN 410, 414. For example, the edge compute nodes can provide a connection between the RAN 414 and UPF 448 in the 5GC 440. The edge compute nodes can use one or more NFV instances instantiated on virtualization infrastructure within the edge compute nodes to process wireless connections to and from the RAN 414 and UPF 448.

The interfaces of the 5GC 440 include reference points and service-based interfaces. The reference points include: N1 (between the UE 402 and the AMF 444), N2 (between RAN 414 and AMF 444), N3 (between RAN 414 and UPF 448), N4 (between the SMF 446 and UPF 448), N5 (between PCF 456 and AF 460), N6 (between UPF 448 and DN 436), N7 (between SMF 446 and PCF 456), N8 (between UDM 458 and AMF 444), N9 (between two UPFs 448), N10 (between the UDM 458 and the SMF 446), N11 (between the AMF 444 and the SMF 446), N12 (between AUSF 442 and AMF 444), N13 (between AUSF 442 and UDM 458), N14 (between two AMFs 444; not shown), N15 (between PCF 456 and AMF 444 in case of a non-roaming scenario, or between the PCF 456 in a visited network and AMF 444 in case of a roaming scenario), N16 (between two SMFs 446; not shown), and N22 (between AMF 444 and NSSF 450). Other reference point representations not shown in FIG. 4 can also be used. The service-based representation of FIG. 4 represents NFs within the control plane that enable other authorized NFs to access their services. The service-based interfaces (SBIs) include: Namf (SBI exhibited by AMF 444), Nsmf (SBI exhibited by SMF 446), Nnef (SBI exhibited by NEF 452), Npcf (SBI exhibited by PCF 456), Nudm (SBI exhibited by the UDM 458), Naf (SBI exhibited by AF 460), Nnrf (SBI exhibited by NRF 454), Nnssf (SBI exhibited by NSSF 450), Nausf (SBI exhibited by AUSF 442). Other service-based interfaces (e.g., Nudr, N5g-eir, and Nudsf) not shown in FIG. 4 can also be used. In some embodiments, the NEF 452 can provide an interface to edge compute nodes 436x, which can be used to process wireless connections with the RAN 414. In some implementations, the system 400 may include an SMSF, which is responsible for SMS subscription checking and verification, and relaying SM messages to/from the UE 402 to/from other entities, such as an SMS-GMSC/IWMSC/SMS-router. The SMS may also interact with AMF 444 and UDM 458 for a notification procedure that the UE 402 is available for SMS transfer (e.g., set a UE not reachable flag, and notifying UDM 458 when UE 402 is available for SMS).

The 5GS may also include an SCP (or individual instances of the SCP) that supports indirect communication (see e.g., 3GPP TS 23.501 section 7.1.1); delegated discovery (see e.g., 3GPP TS 23.501 section 7.1.1); message forwarding and routing to destination NF/NF service(s), communication security (e.g., authorization of the NF Service Consumer to access the NF Service Producer API) (see e.g., 3GPP TS 33.501), load balancing, monitoring, overload control, etc.; and discovery and selection functionality for UDM(s), AUSF(s), UDR(s), PCF(s) with access to subscription data stored in the UDR based on UE's SUPI, SUCI or GPSI (see e.g., 3GPP TS 23.501 section 6.3). Load balancing, monitoring, overload control functionality provided by the SCP may be implementation specific. The SCP may be deployed in a distributed manner. More than one SCP can be present in the communication path between various NF Services. The SCP, although not an NF instance, can also be deployed distributed, redundant, and scalable.

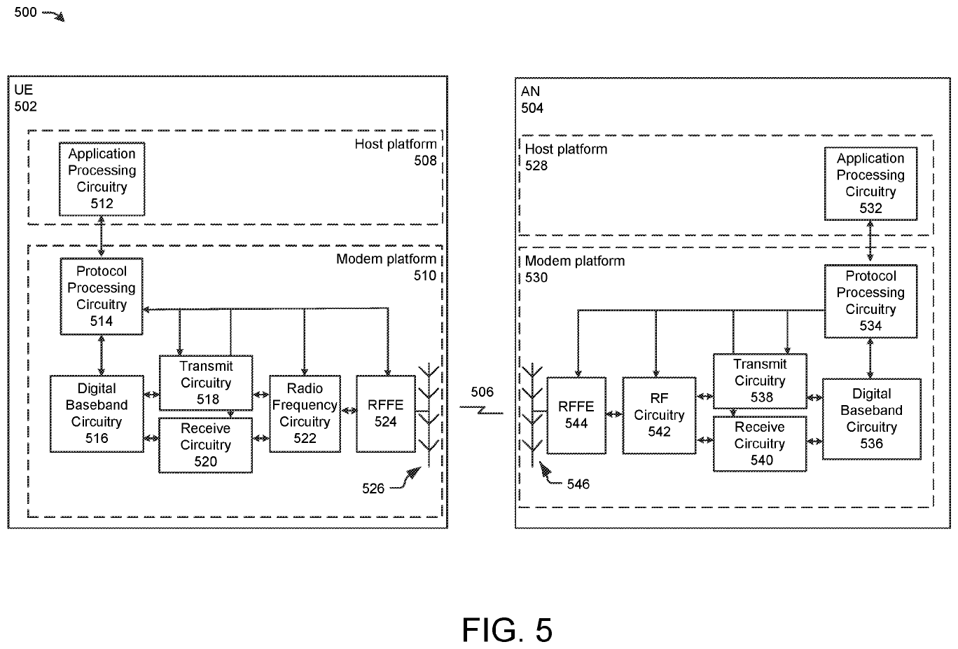

FIG. 5 schematically illustrates a wireless network 500 in accordance with various embodiments. The wireless network 500 may include a UE 502 in wireless communication with an AN 504. The UE 502 and AN 504 may be similar to, and substantially interchangeable with, like-named components described with respect to FIG. 4.

The UE 502 may be communicatively coupled with the AN 504 via connection 506.

The connection 506 is illustrated as an air interface to enable communicative coupling, and can be consistent with cellular communications protocols such as an LTE protocol or a 5G NR protocol operating at mmWave or sub-6 GHZ frequencies.

The UE 502 may include a host platform 508 coupled with a modem platform 510. The host platform 508 may include application processing circuitry 512, which may be coupled with protocol processing circuitry 514 of the modem platform 510. The application processing circuitry 512 may run various applications for the UE 502 that source/sink application data. The application processing circuitry 512 may further implement one or more layer operations to transmit/receive application data to/from a data network. These layer operations may include transport (for example UDP) and Internet (for example, IP) operations

The protocol processing circuitry 514 may implement one or more of layer operations to facilitate transmission or reception of data over the connection 506. The layer operations implemented by the protocol processing circuitry 514 may include, for example, MAC, RLC, PDCP, RRC and NAS operations.

The modem platform 510 may further include digital baseband circuitry 516 that may implement one or more layer operations that are “below” layer operations performed by the protocol processing circuitry 514 in a network protocol stack. These operations may include, for example, PHY operations including one or more of HARQ acknowledgement (ACK) functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 510 may further include transmit circuitry 518, receive circuitry 520, RF circuitry 522, and RF front end (RFFE) 524, which may include or connect to one or more antenna panels 526. Briefly, the transmit circuitry 518 may include a digital-to-analog converter, mixer, intermediate frequency (IF) components, etc.; the receive circuitry 520 may include an analog-to-digital converter, mixer, IF components, etc.; the RF circuitry 522 may include a low-noise amplifier, a power amplifier, power tracking components, etc.; RFFE 524 may include filters (for example, surface/bulk acoustic wave filters), switches, antenna tuners, beamforming components (for example, phase-array antenna components), etc. The selection and arrangement of the components of the transmit circuitry 518, receive circuitry 520, RF circuitry 522, RFFE 524, and antenna panels 526 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 514 may include one or more instances of control circuitry (not shown) to provide control functions for the transmit/receive components.

A UE 502 reception may be established by and via the antenna panels 526, RFFE 524, RF circuitry 522, receive circuitry 520, digital baseband circuitry 516, and protocol processing circuitry 514. In some embodiments, the antenna panels 526 may receive a transmission from the AN 504 by receive-beamforming signals received by a plurality of antennas/antenna elements of the one or more antenna panels 526.

A UE 502 transmission may be established by and via the protocol processing circuitry 514, digital baseband circuitry 516, transmit circuitry 518, RF circuitry 522, RFFE 524, and antenna panels 526. In some embodiments, the transmit components of the UE 504 may apply a spatial filter to the data to be transmitted to form a transmit beam emitted by the antenna elements of the antenna panels 526.

Similar to the UE 502, the AN 504 may include a host platform 528 coupled with a modem platform 530. The host platform 528 may include application processing circuitry 532 coupled with protocol processing circuitry 534 of the modem platform 530. The modem platform may further include digital baseband circuitry 536, transmit circuitry 538, receive circuitry 540, RF circuitry 542, RFFE circuitry 544, and antenna panels 546. The components of the AN 504 may be similar to and substantially interchangeable with like-named components of the UE 502. In addition to performing data transmission/reception as described above, the components of the AN 508 may perform various logical functions that include, for example, RNC functions such as radio bearer management, uplink and downlink dynamic radio resource management, and data packet scheduling.

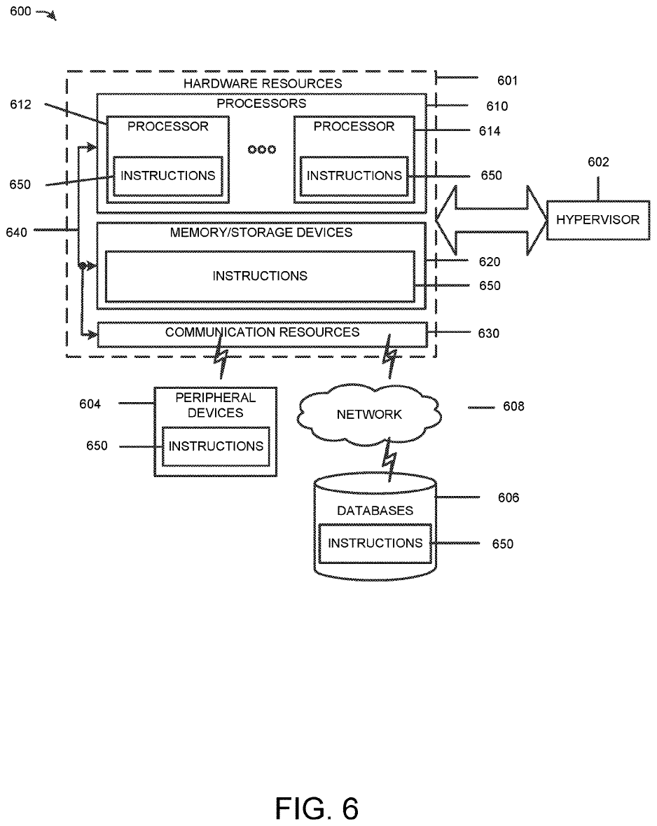

FIG. 6 illustrates components of a computing device 600 according to some example embodiments, able to read instructions from a machine-readable or computer-readable medium (e.g., a non-transitory machine-readable storage medium) and perform any one or more of the methodologies discussed herein. Specifically, FIG. 6 shows a diagrammatic representation of hardware resources 601 including one or more processors (or processor cores) 610, one or more memory/storage devices 620, and one or more communication resources 630, each of which may be communicatively coupled via a bus 640 or other interface circuitry. For embodiments where node virtualization (e.g., NFV) is utilized, a hypervisor 602 may be executed to provide an execution environment for one or more network slices/sub-slices to utilize the hardware resources 601.

The processors 610 include, for example, processor 612 and processor 614. The processors 610 include circuitry such as, but not limited to one or more processor cores and one or more of cache memory, low drop-out voltage regulators (LDOs), interrupt controllers, serial interfaces such as SPI, I2C or universal programmable serial interface circuit, real time clock (RTC), timer-counters including interval and watchdog timers, general purpose I/O, memory card controllers such as secure digital/multi-media card (SD/MMC) or similar, interfaces, mobile industry processor interface (MIPI) interfaces and Joint Test Access Group (JTAG) test access ports. The processors 610 may be, for example, a central processing unit (CPU), reduced instruction set computing (RISC) processors, Acorn RISC Machine (ARM) processors, complex instruction set computing (CISC) processors, graphics processing units (GPUs), one or more Digital Signal Processors (DSPs) such as a baseband processor, Application-Specific Integrated Circuits (ASICs), an Field-Programmable Gate Array (FPGA), a radio-frequency integrated circuit (RFIC), one or more microprocessors or controllers, another processor (including those discussed herein), or any suitable combination thereof. In some implementations, the processor circuitry 610 may include one or more hardware accelerators, which may be microprocessors, programmable processing devices (e.g., FPGA, complex programmable logic devices (CPLDs), etc.), or the like.

The memory/storage devices 620 may include main memory, disk storage, or any suitable combination thereof. The memory/storage devices 620 may include, but are not limited to, any type of volatile, non-volatile, or semi-volatile memory such as random access memory (RAM), dynamic RAM (DRAM), static RAM (SRAM), synchronous DRAM (SDRAM), erasable programmable read-only memory (EPROM), electrically erasable programmable read-only memory (EEPROM), Flash memory, solid-state storage, phase change RAM (PRAM), resistive memory such as magnetoresistive random access memory (MRAM), etc., and may incorporate three-dimensional (3D) cross-point (XPOINT) memories from Intel® and Micron®. The memory/storage devices 620 may also comprise persistent storage devices, which may be temporal and/or persistent storage of any type, including, but not limited to, non-volatile memory, optical, magnetic, and/or solid state mass storage, and so forth.

The communication resources 630 may include interconnection or network interface controllers, components, or other suitable devices to communicate with one or more peripheral devices 604 or one or more databases 606 or other network elements via a network 608. For example, the communication resources 630 may include wired communication components (e.g., for coupling via USB, Ethernet, Ethernet, Ethernet over GRE Tunnels, Ethernet over Multiprotocol Label Switching (MPLS), Ethernet over USB, Controller Area Network (CAN), Local Interconnect Network (LIN), DeviceNet, ControlNet, Data Highway+, PROFIBUS, or PROFINET, among many others), cellular communication components, NFC components, Bluetooth® (or Bluetooth® Low Energy) components, WiFiR components, and other communication components. Network connectivity may be provided to/from the computing device 600 via the communication resources 630 using a physical connection, which may be electrical (e.g., a “copper interconnect”) or optical. The physical connection also includes suitable input connectors (e.g., ports, receptacles, sockets, etc.) and output connectors (e.g., plugs, pins, etc.). The communication resources 630 may include one or more dedicated processors and/or FPGAs to communicate using one or more of the aforementioned network interface protocols.

Instructions 650 may comprise software, a program, an application, an applet, an app, or other executable code for causing at least any of the processors 610 to perform any one or more of the methodologies discussed herein. The instructions 650 may reside, completely or partially, within at least one of the processors 610 (e.g., within the processor's cache memory), the memory/storage devices 620, or any suitable combination thereof. Furthermore, any portion of the instructions 650 may be transferred to the hardware resources 601 from any combination of the peripheral devices 604 or the databases 606. Accordingly, the memory of processors 610, the memory/storage devices 620, the peripheral devices 604, and the databases 606 are examples of computer-readable and machine-readable media.

FIG. 7 illustrates a network 700 in accordance with various embodiments. The network 700 may operate in a matter consistent with 3GPP technical specifications or technical reports for 6G systems. In some embodiments, the network 700 may operate concurrently with network 400. For example, in some embodiments, the network 700 may share one or more frequency or bandwidth resources with network 400. As one specific example, a UE (e.g., UE 702) may be configured to operate in both network 700 and network 400. Such configuration may be based on a UE including circuitry configured for communication with frequency and bandwidth resources of both networks 400 and 700. In general, several elements of network 700 may share one or more characteristics with elements of network 400. For the sake of brevity and clarity, such elements may not be repeated in the description of network 700.

The network 700 may include a UE 702, which may include any mobile or non-mobile computing device designed to communicate with a RAN 708 via an over-the-air connection. The UE 702 may be similar to, for example, UE 402. The UE 702 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

Although not specifically shown in FIG. 7, in some embodiments the network 700 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc. Similarly, although not specifically shown in FIG. 7, the UE 702 may be communicatively coupled with an AP such as AP 406 as described with respect to FIG. 4. Additionally, although not specifically shown in FIG. 7, in some embodiments the RAN 708 may include one or more ANss such as AN 408 as described with respect to FIG. 4. The RAN 708 and/or the AN of the RAN 708 may be referred to as a base station (BS), a RAN node, or using some other term or name.

The UE 702 and the RAN 708 may be configured to communicate via an air interface that may be referred to as a sixth generation (6G) air interface. The 6G air interface may include one or more features such as communication in a terahertz (THz) or sub-THz bandwidth, or joint communication and sensing. As used herein, the term “joint communication and sensing” may refer to a system that allows for wireless communication as well as radar-based sensing via various types of multiplexing. As used herein, THz or sub-THz bandwidths may refer to communication in the 80 GHz and above frequency ranges. Such frequency ranges may additionally or alternatively be referred to as “millimeter wave” or “mmWave” frequency ranges.

The RAN 708 may allow for communication between the UE 702 and a 6G core network (CN) 710. Specifically, the RAN 708 may facilitate the transmission and reception of data between the UE 702 and the 6G CN 710. The 6G CN 710 may include various functions such as NSSF 450, NEF 452, NRF 454, PCF 456, UDM 458, AF 460, SMF 446, and AUSF 442. The 6G CN 710 may additional include UPF 448 and DN 436 as shown in FIG. 7.

Additionally, the RAN 708 may include various additional functions that are in addition to, or alternative to, functions of a legacy cellular network such as a 4G or 5G network. Two such functions may include a Compute Control Function (Comp CF) 724 and a Compute Service Function (Comp SF) 736. The Comp CF 724 and the Comp SF 736 may be parts or functions of the Computing Service Plane. Comp CF 724 may be a control plane function that provides functionalities such as management of the Comp SF 736, computing task context generation and management (e.g., create, read, modify, delete), interaction with the underlaying computing infrastructure for computing resource management, etc., Comp SF 736 may be a user plane function that serves as the gateway to interface computing service users (such as UE 702) and computing nodes behind a Comp SF instance. Some functionalities of the Comp SF 736 may include: parse computing service data received from users to compute tasks executable by computing nodes; hold service mesh ingress gateway or service API gateway; service and charging policies enforcement; performance monitoring and telemetry collection, etc. In some embodiments, a Comp SF 736 instance may serve as the user plane gateway for a cluster of computing nodes. A Comp CF 724 instance may control one or more Comp SF 736 instances.

Two other such functions may include a Communication Control Function (Comm CF) 728 and a Communication Service Function (Comm SF) 738, which may be parts of the Communication Service Plane. The Comm CF 728 may be the control plane function for managing the Comm SF 738, communication sessions creation/configuration/releasing, and managing communication session context. The Comm SF 738 may be a user plane function for data transport. Comm CF 728 and Comm SF 738 may be considered as upgrades of SMF 446 and UPF 448, which were described with respect to a 5G system in FIG. 4. The upgrades provided by the Comm CF 728 and the Comm SF 738 may enable service-aware transport. For legacy (e.g., 4G or 5G) data transport, SMF 446 and UPF 448 may still be used.

Two other such functions may include a Data Control Function (Data CF) 722 and Data Service Function (Data SF) 732 may be parts of the Data Service Plane. Data CF 722 may be a control plane function and provides functionalities such as Data SF 732 management, Data service creation/configuration/releasing, Data service context management, etc. Data SF 732 may be a user plane function and serve as the gateway between data service users (such as UE 702 and the various functions of the 6G CN 710) and data service endpoints behind the gateway. Specific functionalities may include include: parse data service user data and forward to corresponding data service endpoints, generate charging data, report data service status.

Another such function may be the Service Orchestration and Chaining Function (SOCF) 720, which may discover, orchestrate and chain up communication/computing/data services provided by functions in the network. Upon receiving service requests from users, SOCF 720 may interact with one or more of Comp CF 724, Comm CF 728, and Data CF 722 to identify Comp SF 736, Comm SF 738, and Data SF 732 instances, configure service resources, and generate the service chain, which could contain multiple Comp SF 736, Comm SF 738, and Data SF 732 instances and their associated computing endpoints. Workload processing and data movement may then be conducted within the generated service chain. The SOCF 720 may also responsible for maintaining, updating, and releasing a created service chain.

Another such function may be the service registration function (SRF) 714, which may act as a registry for system services provided in the user plane such as services provided by service endpoints behind Comp SF 736 and Data SF 732 gateways and services provided by the UE 702. The SRF 714 may be considered a counterpart of NRF 454, which may act as the registry for network functions.

Other such functions may include an evolved service communication proxy (eSCP) and service infrastructure control function (SICF) 726, which may provide service communication infrastructure for control plane services and user plane services. The eSCP may be related to the service communication proxy (SCP) of 5G with user plane service communication proxy capabilities being added. The eSCP is therefore expressed in two parts: eCSP-C 712 and eSCP-U 734, for control plane service communication proxy and user plane service communication proxy, respectively. The SICF 726 may control and configure eCSP instances in terms of service traffic routing policies, access rules, load balancing configurations, performance monitoring, etc.

Another such function is the AMF 744. The AMF 744 may be similar to 444, but with additional functionality. Specifically, the AMF 744 may include potential functional repartition, such as move the message forwarding functionality from the AMF 744 to the RAN 708.

Another such function is the service orchestration exposure function (SOEF) 718. The SOEF may be configured to expose service orchestration and chaining services to external users such as applications.

The UE 702 may include an additional function that is referred to as a computing client service function (comp CSF) 704. The comp CSF 704 may have both the control plane functionalities and user plane functionalities, and may interact with corresponding network side functions such as SOCF 720, Comp CF 724, Comp SF 736, Data CF 722, and/or Data SF 732 for service discovery, request/response, compute task workload exchange, etc. The Comp CSF 704 may also work with network side functions to decide on whether a computing task should be run on the UE 702, the RAN 708, and/or an element of the 6G CN 710.

The UE 702 and/or the Comp CSF 704 may include a service mesh proxy 706. The service mesh proxy 706 may act as a proxy for service-to-service communication in the user plane. Capabilities of the service mesh proxy 706 may include one or more of addressing, security, load balancing, etc.

FIG. 8 illustrates a simplified block diagram of artificial (AI)-assisted communication between a UE 805 and a RAN 810, in accordance with various embodiments. More specifically, as described in further detail below, AI/machine learning (ML) models may be used or leveraged to facilitate over-the-air communication between UE 805 and RAN 810.

One or both of the UE 805 and the RAN 810 may operate in a matter consistent with 3GPP technical specifications or technical reports for 6G systems. In some embodiments, the wireless cellular communication between the UE 805 and the RAN 810 may be part of, or operate concurrently with, networks 700, 400, and/or some other network described herein.

The UE 805 may be similar to, and share one or more features with, UE 702, UE 402, and/or some other UE described herein. The UE 805 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc. The RAN 810 may be similar to, and share one or more features with, RAN 414, RAN 708, and/or some other RAN described herein.

As may be seen in FIG. 8, the AI-related elements of UE 805 may be similar to the AI-related elements of RAN 810. For the sake of discussion herein, description of the various elements will be provided from the point of view of the UE 805, however it will be understood that such discussion or description will apply to equally named/numbered elements of RAN 810, unless explicitly stated otherwise.

As previously noted, the UE 805 may include various elements or functions that are related to AI/ML. Such elements may be implemented as hardware, software, firmware, and/or some combination thereof. In embodiments, one or more of the elements may be implemented as part of the same hardware (e.g., chip or multi-processor chip), software (e.g., a computing program), or firmware as another element.

One such element may be a data repository 815. The data repository 815 may be responsible for data collection and storage. Specifically, the data repository 815 may collect and store RAN configuration parameters, measurement data, performance key performance indicators (KPIs), model performance metrics, etc., for model training, update, and inference. More generally, collected data is stored into the repository. Stored data can be discovered and extracted by other elements from the data repository 815. For example, as may be seen, the inference data selection/filter element 850 may retrieve data from the data repository 815. In various embodiments, the UE 805 may be configured to discover and request data from the data repository 815 in the RAN, and vice versa. More generally, the data repository 815 of the UE 805 may be communicatively coupled with the data repository 815 of the RAN 810 such that the respective data repositories of the UE and the RAN may share collected data with one another.

Another such element may be a training data selection/filtering functional block 820. The training data selection/filter functional block 820 may be configured to generate training, validation, and testing datasets for model training. Training data may be extracted from the data repository 815. Data may be selected/filtered based on the specific AI/ML model to be trained. Data may optionally be transformed/augmented/pre-processed (e.g., normalized) before being loaded into datasets. The training data selection/filter functional block 820 may label data in datasets for supervised learning. The produced datasets may then be fed into model training the model training functional block 825.

As noted above, another such element may be the model training functional block 825. This functional block may be responsible for training and updating (re-training) AI/ML models. The selected model may be trained using the fed-in datasets (including training, validation, testing) from the training data selection/filtering functional block. The model training functional block 825 may produce trained and tested AI/ML models which are ready for deployment. The produced trained and tested models can be stored in a model repository 835.

The model repository 835 may be responsible for AI/ML models' (both trained and un-trained) storage and exposure. Trained/updated model(s) may be stored into the model repository 835. Model and model parameters may be discovered and requested by other functional blocks (e.g., the training data selection/filter functional block 820 and/or the model training functional block 825). In some embodiments, the UE 805 may discover and request AI/ML models from the model repository 835 of the RAN 810. Similarly, the RAN 810 may be able to discover and/or request AI/ML models from the model repository 835 of the UE 805. In some embodiments, the RAN 810 may configure models and/or model parameters in the model repository 835 of the UE 805.

Another such element may be a model management functional block 840. The model management functional block 840 may be responsible for management of the AI/ML model produced by the model training functional block 825. Such management functions may include deployment of a trained model, monitoring model performance, etc. In model deployment, the model management functional block 840 may allocate and schedule hardware and/or software resources for inference, based on received trained and tested models. As used herein, “inference” refers to the process of using trained AI/ML model(s) to generate data analytics, actions, policies, etc. based on input inference data. In performance monitoring, based on wireless performance KPIs and model performance metrics, the model management functional block 840 may decide to terminate the running model, start model re-training, select another model, etc. In embodiments, the model management functional block 840 of the RAN 810 may be able to configure model management policies in the UE 805 as shown.

Another such element may be an inference data selection/filtering functional block 850. The inference data selection/filter functional block 850 may be responsible for generating datasets for model inference at the inference functional block 845, as described below. Specifically, inference data may be extracted from the data repository 815. The inference data selection/filter functional block 850 may select and/or filter the data based on the deployed AI/ML model. Data may be transformed/augmented/pre-processed following the same transformation/augmentation/pre-processing as those in training data selection/filtering as described with respect to functional block 820. The produced inference dataset may be fed into the inference functional block 845.

Another such element may be the inference functional block 845. The inference functional block 845 may be responsible for executing inference as described above. Specifically, the inference functional block 845 may consume the inference dataset provided by the inference data selection/filtering functional block 850, and generate one or more outcomes. Such outcomes may be or include data analytics, actions, policies, etc. The outcome(s) may be provided to the performance measurement functional block 830.

The performance measurement functional block 830 may be configured to measure model performance metrics (e.g., accuracy, model bias, run-time latency, etc.) of deployed and executing models based on the inference outcome(s) for monitoring purpose. Model performance data may be stored in the data repository 815.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section. Additional examples of the presently described embodiments include the following, non-limiting implementations. Each of the following non-limiting examples may stand on its own or may be combined in any permutation or combination with any one or more of the other examples provided below or throughout the present disclosure.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below.

The following examples pertain to further embodiments.

Example 1 may include a device comprising processing circuitry coupled to storage, the processing circuitry configured to: receive a Policy Control and Charging (PCC) rule from a Policy Control Function (PCF), which may include an identifier (ID) for a standardized traffic pattern (STP) and a machine learning model identifier (ML model ID) of an ML model to be used for traffic detection; and send a Packet Detection Rule (PDR) to a User Plane Function (UPF) that may include an STP ID and the ML model ID to initiate an ML based detection of the STP.

Example 2 may include the device of example 1 and/or some other example herein, wherein the processing circuitry may be further configured to transmit a packet detection rule (PDR) to the UPF including the STP ID and ML model ID.

Example 3 may include the device of example 2 and/or some other example herein, wherein the processing circuitry may be further configured to transmit a forwarding action rule (FAR) to steer the traffic detected by the PDR to a quality-of-service flow.

Example 4 may include the device of example 1 and/or some other example herein, wherein the processing circuitry may be further configured to transmit a non-access stratum message to the UE including the STP ID and ML model ID.

Example 5 may include the device of example 4 and/or some other example herein, wherein the non-access stratum message further comprises a uniform resource locator of the ML model.

Example 6 may include the device of example 1 and/or some other example herein, wherein the processing circuitry may be further configured to subscribe to analytics from network data analytics function (NWDAF) model training logical function (MTLF).

Example 7 may include the device of example 6 and/or some other example herein, wherein the NWDAF MTLF provides a trained ML model to NWDAF AnLF identified by an ML model identifier.

Example 8 may include the device of example 6 and/or some other example herein, wherein the trained ML model in NWDAF AnLF provides STP analytics when requested by a service consumer to detect a specific STP.

Example 9 may include the device of example 1 and/or some other example herein, wherein the processing circuitry may be further configured to mark downlink packets with a reflective quality of service (QoS) indicator.

Example 10 may include the device of example 8 and/or some other example herein, wherein the reflective QoS indicator enables the UE to derive a QoS rule for uplink traffic upon receiving the downlink packets.

Example 11 may include the device of example 9 and/or some other example herein, wherein the QoS rule comprises a wildcard for port values in a packet filter.

Example 12 may include a non-transitory computer-readable medium storing computer-executable instructions which when executed by one or more processors result in performing operations comprising: receiving a Policy Control and Charging (PCC) rule from a Policy Control Function (PCF), which may include an identifier (ID) for a standardized traffic pattern (STP) and a machine learning model identifier (ML model ID) of an ML model to be used for traffic detection; and sending a Packet Detection Rule (PDR) to a User Plane Function (UPF) that may include an STP ID and the ML model ID to initiate an ML based detection of the STP.

Example 13 may include the non-transitory computer-readable medium of example 12 and/or some other example herein, wherein the operations further comprise transmitting a packet detection rule (PDR) to the UPF including the STP ID and ML model ID.

Example 14 may include the non-transitory computer-readable medium of example 13 and/or some other example herein, wherein the operations further comprise transmitting a forwarding action rule (FAR) to steer the traffic detected by the PDR to a quality-of-service flow.

Example 15 may include the non-transitory computer-readable medium of example 12 and/or some other example herein, wherein the operations further comprise transmitting a non-access stratum message to the UE including the STP ID and ML model ID.

Example 16 may include the non-transitory computer-readable medium of example 15 and/or some other example herein, wherein the non-access stratum message further comprises a uniform resource locator of the ML model.

Example 17 may include the non-transitory computer-readable medium of example 12 and/or some other example herein, wherein the operations further comprise subscribe to analytics from network data analytics function (NWDAF) model training logical function (MTLF).

Example 18 may include the non-transitory computer-readable medium of example 17 and/or some other example herein, wherein the NWDAF MTLF provides a trained ML model to NWDAF AnLF identified by an ML model identifier.

Example 19 may include the non-transitory computer-readable medium of example 17 and/or some other example herein, wherein the trained ML model in NWDAF AnLF provides STP analytics when requested by a service consumer to detect a specific STP.

Example 20 may include the non-transitory computer-readable medium of example 12 and/or some other example herein, wherein the operations further comprise mark downlink packets with a reflective quality of service (QoS) indicator.

Example 21 may include the non-transitory computer-readable medium of example 19 and/or some other example herein, wherein the reflective QoS indicator enables the UE to derive a QoS rule for uplink traffic upon receiving the downlink packets.

Example 22 may include the non-transitory computer-readable medium of example 20 and/or some other example herein, wherein the QoS rule comprises a wildcard for port values in a packet filter.

Example 23 may include a method comprising: receiving a Policy Control and Charging (PCC) rule at a Session Management Function (SMF) from a Policy Control Function (PCF); processing the PCC rule to include identifiers for both a Standardized Traffic Profile (STP) and an ML model; instructing User Equipment (UE) via an N1 reference point to initiate detection of the STP using the identified ML model.

Example 24 may include the method of example 23 and/or some other example herein, wherein the PCF initiates detection of the STP by forwarding the PCC rule to the SMF, which may include the STP identifier (ID) and the ML model ID for the traffic detection.

Example 25 may include the method of example 24 and/or some other example herein, wherein the STP ID in the PCC rule may be subsumed under the Application ID in the PCC rule communicated via a N7 reference point.

Example 26 may include the method of example 23 and/or some other example herein, wherein the UE fetches the indicated ML model from an application server in the data network that acts as an ML model repository.

Example 27 may include the method of example 23 and/or some other example herein, whereby upon successful detection of the STP, the UE directs the uplink packets of this STP to a pre-established Quality of Service (QoS) Flow.

Example 28 may include the method of example 27 and/or some other example herein, where the direction of uplink packets may be guided by a QoS Flow Identifier (QFI) as detailed in the QoS rule.

Example 29 may include the method of example 26 and/or some other example herein, wherein the application server updates the ML model based on feedback received from the UEs about the detection efficacy, and the updated ML model may be automatically downloaded by the UE.

Example 30 may include an apparatus comprising means for: receiving a Policy Control and Charging (PCC) rule from a Policy Control Function (PCF), which may include an identifier (ID) for a standardized traffic pattern (STP) and a machine learning model identifier (ML model ID) of an ML model to be used for traffic detection; and sending a Packet Detection Rule (PDR) to a User Plane Function (UPF) that may include an STP ID and the ML model ID to initiate an ML based detection of the STP.

Example 31 may include the apparatus of example 30 and/or some other example herein, further comprising transmitting a packet detection rule (PDR) to the UPF including the STP ID and ML model ID.

Example 32 may include the apparatus of example 31 and/or some other example herein, further comprising transmitting a forwarding action rule (FAR) to steer the traffic detected by the PDR to a quality-of-service flow.

Example 33 may include the apparatus of example 30 and/or some other example herein, further comprising transmitting a non-access stratum message to the UE including the STP ID and ML model ID.

Example 34 may include the apparatus of example 33 and/or some other example herein, wherein the non-access stratum message further comprises a uniform resource locator of the ML model.

Example 35 may include the apparatus of example 30 and/or some other example herein, further comprising subscribe to analytics from network data analytics function (NWDAF) model training logical function (MTLF).

Example 36 may include the apparatus of example 35 and/or some other example herein, wherein the NWDAF MTLF provides a trained ML model to NWDAF AnLF identified by an ML model identifier.

Example 37 may include the apparatus of example 35 and/or some other example herein, wherein the trained ML model in NWDAF AnLF provides STP analytics when requested by a service consumer to detect a specific STP.

Example 38 may include the apparatus of example 30 and/or some other example herein, further comprising mark downlink packets with a reflective quality of service (QoS) indicator.

Example 39 may include the apparatus of example 37 and/or some other example herein, wherein the reflective QoS indicator enables the UE to derive a QoS rule for uplink traffic upon receiving the downlink packets.

Example 40 may include the apparatus of example 38 and/or some other example herein, wherein the QoS rule comprises a wildcard for port values in a packet filter.

Example 41 may include an apparatus comprising means for performing any of the methods of examples 1-40.

Example 42 may include a network node comprising a communication interface and processing circuitry connected thereto and configured to perform the methods of examples 1-40.

Example 43 may include an apparatus comprising means to perform one or more elements of a method described in or related to any of examples 1-40, or any other method or process described herein.

Example 44 may include one or more non-transitory computer-readable media comprising instructions to cause an electronic device, upon execution of the instructions by one or more processors of the electronic device, to perform one or more elements of a method described in or related to any of examples 1-40, or any other method or process described herein.

Example 45 may include an apparatus comprising logic, modules, or circuitry to perform one or more elements of a method described in or related to any of examples 1-40, or any other method or process described herein.

Example 46 may include a method, technique, or process as described in or related to any of examples 1-40, or portions or parts thereof.

Example 47 may include an apparatus comprising: one or more processors and one or more computer-readable media comprising instructions that, when executed by the one or more processors, cause the one or more processors to perform the method, techniques, or process as described in or related to any of examples 1-40, or portions thereof.

Example 48 may include a signal as described in or related to any of examples 1-40, or portions or parts thereof.

Example 49 may include a datagram, packet, frame, segment, protocol data unit (PDU), or message as described in or related to any of examples 1-40, or portions or parts thereof, or otherwise described in the present disclosure.

Example 50 may include a signal encoded with data as described in or related to any of examples 1-40, or portions or parts thereof, or otherwise described in the present disclosure.

Example 51 may include a signal encoded with a datagram, packet, frame, segment, protocol data unit (PDU), or message as described in or related to any of examples 1-40, or portions or parts thereof, or otherwise described in the present disclosure.

Example 52 may include an electromagnetic signal carrying computer-readable instructions, wherein execution of the computer-readable instructions by one or more processors is to cause the one or more processors to perform the method, techniques, or process as described in or related to any of examples 1-40, or portions thereof.

Example 53 may include a computer program comprising instructions, wherein execution of the program by a processing element is to cause the processing element to carry out the method, techniques, or process as described in or related to any of examples 1-40, or portions thereof.

Example 54 may include a signal in a wireless network as shown and described herein.

Example 55 may include a method of communicating in a wireless network as shown and described herein.

Example 56 may include a system for providing wireless communication as shown and described herein.

Example 57 may include a device for providing wireless communication as shown and described herein.

An example implementation is an edge computing system, including respective edge processing devices and nodes to invoke or perform the operations of the examples above, or other subject matter described herein. Another example implementation is a client endpoint node, operable to invoke or perform the operations of the examples above, or other subject matter described herein. Another example implementation is an aggregation node, network hub node, gateway node, or core data processing node, within or coupled to an edge computing system, operable to invoke or perform the operations of the examples above, or other subject matter described herein. Another example implementation is an access point, base station, road-side unit, street-side unit, or on-premise unit, within or coupled to an edge computing system, operable to invoke or perform the operations of the examples above, or other subject matter described herein. Another example implementation is an edge provisioning node, service orchestration node, application orchestration node, or multi-tenant management node, within or coupled to an edge computing system, operable to invoke or perform the operations of the examples above, or other subject matter described herein. Another example implementation is an edge node operating an edge provisioning service, application or service orchestration service, virtual machine deployment, container deployment, function deployment, and compute management, within or coupled to an edge computing system, operable to invoke or perform the operations of the examples above, or other subject matter described herein. Another example implementation is an edge computing system operable as an edge mesh, as an edge mesh with side car loading, or with mesh-to-mesh communications, operable to invoke or perform the operations of the examples above, or other subject matter described herein. Another example implementation is an edge computing system including aspects of network functions, acceleration functions, acceleration hardware, storage hardware, or computation hardware resources, operable to invoke or perform the use cases discussed herein, with use of the examples above, or other subject matter described herein. Another example implementation is an edge computing system adapted for supporting client mobility, vehicle-to-vehicle (V2V), vehicle-to-everything (V2X), or vehicle-to-infrastructure (V2I) scenarios, and optionally operating according to ETSI MEC specifications, operable to invoke or perform the use cases discussed herein, with use of the examples above, or other subject matter described herein. Another example implementation is an edge computing system adapted for mobile wireless communications, including configurations according to an 3GPP 4G/LTE or 5G network capabilities, operable to invoke or perform the use cases discussed herein, with use of the examples above, or other subject matter described herein. Another example implementation is a computing system adapted for network communications, including configurations according to an O-RAN capabilities, operable to invoke or perform the use cases discussed herein, with use of the examples above, or other subject matter described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### Terminology

The terminology used herein is for the purpose of describing particular embodiments only and is not intended to be limiting of the disclosure. As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C). The description may use the phrases “in an embodiment,” or “In some embodiments,” which may each refer to one or more of the same or different embodiments. Furthermore, the terms “comprising,” “including,” “having,” and the like, as used with respect to embodiments of the present disclosure, are synonymous.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or ink, and/or the like.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “memory” and/or “memory circuitry” as used herein refers to one or more hardware devices for storing data, including RAM, MRAM, PRAM, DRAM, and/or SDRAM, core memory, ROM, magnetic disk storage mediums, optical storage mediums, flash memory devices or other machine readable mediums for storing data. The term “computer-readable medium” may include, but is not limited to, memory, portable or fixed storage devices, optical storage devices, and various other mediums capable of storing, containing or carrying instructions or data.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource. The term “element” refers to a unit that is indivisible at a given level of abstraction and has a clearly defined boundary, wherein an element may be any type of entity including, for example, one or more devices, systems, controllers, network elements, modules, etc., or combinations thereof. The term “device” refers to a physical entity embedded inside, or attached to, another physical entity in its vicinity, with capabilities to convey digital information from or to that physical entity. The term “entity” refers to a distinct component of an architecture or device, or information transferred as a payload. The term “controller” refers to an element or entity that has the capability to affect a physical entity, such as by changing its state or causing the physical entity to move.

The term “cloud computing” or “cloud” refers to a paradigm for enabling network access to a scalable and elastic pool of shareable computing resources with self-service provisioning and administration on-demand and without active management by users. Cloud computing provides cloud computing services (or cloud services), which are one or more capabilities offered via cloud computing that are invoked using a defined interface (e.g., an API or the like). The term “computing resource” or simply “resource” refers to any physical or virtual component, or usage of such components, of limited availability within a computer system or network. Examples of computing resources include usage/access to, for a period of time, servers, processor(s), storage equipment, memory devices, memory areas, networks, electrical power, input/output (peripheral) devices, mechanical devices, network connections (e.g., channels/links, ports, network sockets, etc.), operating systems, virtual machines (VMs), software/applications, computer files, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable. As used herein, the term “cloud service provider” (or CSP) indicates an organization which operates typically large-scale “cloud” resources comprised of centralized, regional, and edge data centers (e.g., as used in the context of the public cloud). In other examples, a CSP may also be referred to as a Cloud Service Operator (CSO). References to “cloud computing” generally refer to computing resources and services offered by a CSP or a CSO, at remote locations with at least some increased latency, distance, or constraints relative to edge computing.

As used herein, the term “data center” refers to a purpose-designed structure that is intended to house multiple high-performance compute and data storage nodes such that a large amount of compute, data storage and network resources are present at a single location. This often entails specialized rack and enclosure systems, suitable heating, cooling, ventilation, security, fire suppression, and power delivery systems. The term may also refer to a compute and data storage node in some contexts. A data center may vary in scale between a centralized or cloud data center (e.g., largest), regional data center, and edge data center (e.g., smallest).

As used herein, the term “edge computing” refers to the implementation, coordination, and use of computing and resources at locations closer to the “edge” or collection of “edges” of a network. Deploying computing resources at the network's edge may reduce application and network latency, reduce network backhaul traffic and associated energy consumption, improve service capabilities, improve compliance with security or data privacy requirements (especially as compared to conventional cloud computing), and improve total cost of ownership). As used herein, the term “edge compute node” refers to a real-world, logical, or virtualized implementation of a compute-capable element in the form of a device, gateway, bridge, system or subsystem, component, whether operating in a server, client, endpoint, or peer mode, and whether located at an “edge” of an network or at a connected location further within the network. References to a “node” used herein are generally interchangeable with a “device”, “component”, and “sub-system”; however, references to an “edge computing system” or “edge computing network” generally refer to a distributed architecture, organization, or collection of multiple nodes and devices, and which is organized to accomplish or offer some aspect of services or resources in an edge computing setting.

Additionally or alternatively, the term “Edge Computing” refers to a concept, as described in [6], that enables operator and 3rd party services to be hosted close to the UE's access point of attachment, to achieve an efficient service delivery through the reduced end-to-end latency and load on the transport network. As used herein, the term “Edge Computing Service Provider” refers to a mobile network operator or a 3rd party service provider offering Edge Computing service. As used herein, the term “Edge Data Network” refers to a local Data Network (DN) that supports the architecture for enabling edge applications. As used herein, the term “Edge Hosting Environment” refers to an environment providing support required for Edge Application Server's execution. As used herein, the term “Application Server” refers to application software resident in the cloud performing the server function.

The term “Internet of Things” or “IoT” refers to a system of interrelated computing devices, mechanical and digital machines capable of transferring data with little or no human interaction, and may involve technologies such as real-time analytics, machine learning and/or AI, embedded systems, wireless sensor networks, control systems, automation (e.g., smarthome, smart building and/or smart city technologies), and the like. IoT devices are usually low-power devices without heavy compute or storage capabilities. “Edge IoT devices” may be any kind of IoT devices deployed at a network's edge.

As used herein, the term “cluster” refers to a set or grouping of entities as part of an edge computing system (or systems), in the form of physical entities (e.g., different computing systems, networks or network groups), logical entities (e.g., applications, functions, security constructs, containers), and the like. In some locations, a “cluster” is also referred to as a “group” or a “domain”. The membership of cluster may be modified or affected based on conditions or functions, including from dynamic or property-based membership, from network or system management scenarios, or from various example techniques discussed below which may add, modify, or remove an entity in a cluster. Clusters may also include or be associated with multiple layers, levels, or properties, including variations in security features and results based on such layers, levels, or properties.

The term “application” may refer to a complete and deployable package, environment to achieve a certain function in an operational environment. The term “AI/ML application” or the like may be an application that contains some AI/ML models and application-level descriptions. The term “machine learning” or “ML” refers to the use of computer systems implementing algorithms and/or statistical models to perform specific task(s) without using explicit instructions, but instead relying on patterns and inferences. ML algorithms build or estimate mathematical model(s) (referred to as “ML models” or the like) based on sample data (referred to as “training data,” “model training information,” or the like) in order to make predictions or decisions without being explicitly programmed to perform such tasks.

Generally, an ML algorithm is a computer program that learns from experience with respect to some task and some performance measure, and an ML model may be any object or data structure created after an ML algorithm is trained with one or more training datasets. After training, an ML model may be used to make predictions on new datasets. Although the term “ML algorithm” refers to different concepts than the term “ML model,” these terms as discussed herein may be used interchangeably for the purposes of the present disclosure.

The term “machine learning model,” “ML model,” or the like may also refer to ML methods and concepts used by an ML-assisted solution. An “ML-assisted solution” is a solution that addresses a specific use case using ML algorithms during operation. ML models include supervised learning (e.g., linear regression, k-nearest neighbor (KNN), decision tree algorithms, support machine vectors, Bayesian algorithm, ensemble algorithms, etc.) unsupervised learning (e.g., K-means clustering, principle component analysis (PCA), etc.), reinforcement learning (e.g., Q-learning, multi-armed bandit learning, deep RL, etc.), neural networks, and the like. Depending on the implementation a specific ML model could have many sub-models as components and the ML model may train all sub-models together. Separately trained ML models can also be chained together in an ML pipeline during inference. An “ML pipeline” is a set of functionalities, functions, or functional entities specific for an ML-assisted solution; an ML pipeline may include one or several data sources in a data pipeline, a model training pipeline, a model evaluation pipeline, and an actor. The “actor” is an entity that hosts an ML assisted solution using the output of the ML model inference). The term “ML training host” refers to an entity, such as a network function, that hosts the training of the model. The term “ML inference host” refers to an entity, such as a network function, that hosts model during inference mode (which includes both the model execution as well as any online learning if applicable). The ML-host informs the actor about the output of the ML algorithm, and the actor takes a decision for an action (an “action” is performed by an actor as a result of the output of an ML assisted solution). The term “model inference information” refers to information used as an input to the ML model for determining inference(s); the data used to train an ML model and the data used to determine inferences may overlap, however, “training data” and “inference data” refer to different concepts.

The terms “instantiate,” “instantiation,” and the like as used herein refers to the creation of an instance. An “instance” also refers to a concrete occurrence of an object, which may occur, for example, during execution of program code. The term “information element” refers to a structural element containing one or more fields. The term “field” refers to individual contents of an information element, or a data element that contains content. As used herein, a “database object”, “data structure”, or the like may refer to any representation of information that is in the form of an object, attribute-value pair (AVP), key-value pair (KVP), tuple, etc., and may include variables, data structures, functions, methods, classes, database records, database fields, database entities, associations between data and/or database entities (also referred to as a “relation”), blocks and links between blocks in block chain implementations, and/or the like.

An “information object,” as used herein, refers to a collection of structured data and/or any representation of information, and may include, for example electronic documents (or “documents”), database objects, data structures, files, audio data, video data, raw data, archive files, application packages, and/or any other like representation of information. The terms “electronic document” or “document,” may refer to a data structure, computer file, or resource used to record data, and includes various file types and/or data formats such as word processing documents, spreadsheets, slide presentations, multimedia items, webpage and/or source code documents, and/or the like. As examples, the information objects may include markup and/or source code documents such as HTML, XML, JSON, Apex®, CSS, JSP, MessagePack™, Apache® Thrift™, ASN.1, Google® Protocol Buffers (protobuf), or some other document(s)/format(s) such as those discussed herein. An information object may have both a logical and a physical structure. Physically, an information object comprises one or more units called entities. An entity is a unit of storage that contains content and is identified by a name. An entity may refer to other entities to cause their inclusion in the information object. An information object begins in a document entity, which is also referred to as a root element (or “root”). Logically, an information object comprises one or more declarations, elements, comments, character references, and processing instructions, all of which are indicated in the information object (e.g., using markup).

The term “data item” as used herein refers to an atomic state of a particular object with at least one specific property at a certain point in time. Such an object is usually identified by an object name or object identifier, and properties of such an object are usually defined as database objects (e.g., fields, records, etc.), object instances, or data elements (e.g., mark-up language elements/tags, etc.). Additionally or alternatively, the term “data item” as used herein may refer to data elements and/or content items, although these terms may refer to difference concepts. The term “data element” or “element” as used herein refers to a unit that is indivisible at a given level of abstraction and has a clearly defined boundary. A data element is a logical component of an information object (e.g., electronic document) that may begin with a start tag (e.g., “<element>”) and end with a matching end tag (e.g., “</element>”), or only has an empty element tag (e.g., “<element/>”). Any characters between the start tag and end tag, if any, are the element's content (referred to herein as “content items” or the like).

The content of an entity may include one or more content items, each of which has an associated datatype representation. A content item may include, for example, attribute values, character values, URIs, qualified names (qnames), parameters, and the like. A qname is a fully qualified name of an element, attribute, or identifier in an information object. A qname associates a URI of a namespace with a local name of an element, attribute, or identifier in that namespace. To make this association, the qname assigns a prefix to the local name that corresponds to its namespace. The qname comprises a URI of the namespace, the prefix, and the local name. Namespaces are used to provide uniquely named elements and attributes in information objects. Content items may include text content (e.g., “<element>content item</element>”), attributes (e.g., “<element attribute=” attributeValue “>”), and other elements referred to as “child elements” (e.g., “<element1><element2>content item</element2></element1>”). An “attribute” may refer to a markup construct including a name-value pair that exists within a start tag or empty element tag. Attributes contain data related to its element and/or control the element's behavior.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable. The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information. As used herein, the term “radio technology” refers to technology for wireless transmission and/or reception of electromagnetic radiation for information transfer. The term “radio access technology” or “RAT” refers to the technology used for the underlying physical connection to a radio based communication network. As used herein, the term “communication protocol” (either wired or wireless) refers to a set of standardized rules or instructions implemented by a communication device and/or system to communicate with other devices and/or systems, including instructions for packetizing/depacketizing data, modulating/demodulating signals, implementation of protocols stacks, and/or the like.

As used herein, the term “radio technology” refers to technology for wireless transmission and/or reception of electromagnetic radiation for information transfer. The term “radio access technology” or “RAT” refers to the technology used for the underlying physical connection to a radio based communication network. As used herein, the term “communication protocol” (either wired or wireless) refers to a set of standardized rules or instructions implemented by a communication device and/or system to communicate with other devices and/or systems, including instructions for packetizing/depacketizing data, modulating/demodulating signals, implementation of protocols stacks, and/or the like. Examples of wireless communications protocols may be used in various embodiments include a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology including, for example, 3GPP Fifth Generation (5G) or New Radio (NR), Universal Mobile Telecommunications System (UMTS), Freedom of Multimedia Access (FOMA), Long Term Evolution (LTE), LTE-Advanced (LTE Advanced), LTE Extra, LTE-A Pro, cdmaOne (2G), Code Division Multiple Access 2000 (CDMA 2000), Cellular Digital Packet Data (CDPD), Mobitex, Circuit Switched Data (CSD), High-Speed CSD (HSCSD), Universal Mobile Telecommunications System (UMTS), Wideband Code Division Multiple Access (W-CDM), High Speed Packet Access (HSPA), HSPA Plus (HSPA+), Time Division-Code Division Multiple Access (TD-CDMA), Time Division-Synchronous Code Division Multiple Access (TD-SCDMA), LTE LAA, MuLTEfire, UMTS Terrestrial Radio Access (UTRA), Evolved UTRA (E-UTRA), Evolution-Data Optimized or Evolution-Data Only (EV-DO), Advanced Mobile Phone System (AMPS), Digital AMPS (D-AMPS), Total Access Communication System/Extended Total Access Communication System (TACS/ETACS), Push-to-talk (PTT), Mobile Telephone System (MTS), Improved Mobile Telephone System (IMTS), Advanced Mobile Telephone System (AMTS), Cellular Digital Packet Data (CDPD), DataTAC, Integrated Digital Enhanced Network (iDEN), Personal Digital Cellular (PDC), Personal Handy-phone System (PHS), Wideband Integrated Digital Enhanced Network (WiDEN), iBurst, Unlicensed Mobile Access (UMA), also referred to as also referred to as 3GPP Generic Access Network, or GAN standard), Bluetooth®, Bluetooth Low Energy (BLE), IEEE 802.15.4 based protocols (e.g., IPv6 over Low power Wireless Personal Area Networks (6LoWPAN), WirelessHART, MiWi, Thread, 802.11a, etc.) WiFi-direct, ANT/ANT+, ZigBee, Z-Wave, 3GPP device-to-device (D2D) or Proximity Services (ProSe), Universal Plug and Play (UPnP), Low-Power Wide-Area-Network (LPWAN), Long Range Wide Area Network (LoRA) or LoRaWAN™ developed by Semtech and the LoRa Alliance, Sigfox, Wireless Gigabit Alliance (WiGig) standard, Worldwide Interoperability for Microwave Access (WiMAX), mmWave standards in general (e.g., wireless systems operating at 10-300 GHz and above such as WiGig, IEEE 802.11ad, IEEE 802.11ay, etc.), V2X communication technologies (including 3GPP C-V2X), Dedicated Short Range Communications (DSRC) communication systems such as Intelligent-Transport-Systems (ITS) including the European ITS-G5, ITS-G5B, ITS-G5C, etc. In addition to the standards listed above, any number of satellite uplink technologies may be used for purposes of the present disclosure including, for example, radios compliant with standards issued by the International Telecommunication Union (ITU), or the European Telecommunications Standards Institute (ETSI), among others. The examples provided herein are thus understood as being applicable to various other communication technologies, both existing and not yet formulated.

The term “access network” refers to any network, using any combination of radio technologies, RATs, and/or communication protocols, used to connect user devices and service providers. In the context of WLANs, an “access network” is an IEEE 802 local area network (LAN) or metropolitan area network (MAN) between terminals and access routers connecting to provider services. The term “access router” refers to router that terminates a medium access control (MAC) service from terminals and forwards user traffic to information servers according to Internet Protocol (IP) addresses.

The term “SMTC” refers to an SSB-based measurement timing configuration configured by SSB-MeasurementTimingConfiguration. The term “SSB” refers to a synchronization signal/Physical Broadcast Channel (SS/PBCH) block, which includes a Primary Syncrhonization Signal (PSS), a Secondary Syncrhonization Signal (SSS), and a PBCH. The term “a “Primary Cell” refers to the MCG cell, operating on the primary frequency, in which the UE either performs the initial connection establishment procedure or initiates the connection re-establishment procedure. The term “Primary SCG Cell” refers to the SCG cell in which the UE performs random access when performing the Reconfiguration with Sync procedure for DC operation. The term “Secondary Cell” refers to a cell providing additional radio resources on top of a Special Cell for a UE configured with CA. The term “Secondary Cell Group” refers to the subset of serving cells comprising the PSCell and zero or more secondary cells for a UE configured with DC. The term “Serving Cell” refers to the primary cell for a UE in RRC_CONNECTED not configured with CA/DC there is only one serving cell comprising of the primary cell. The term “serving cell” or “serving cells” refers to the set of cells comprising the Special Cell(s) and all secondary cells for a UE in RRC_CONNECTED configured with CA. The term “Special Cell” refers to the PCell of the MCG or the PSCell of the SCG for DC operation; otherwise, the term “Special Cell” refers to the Pcell.

The term “A1 policy” refers to a type of declarative policies expressed using formal statements that enable the non-RT RIC function in the SMO to guide the near-RT RIC function, and hence the RAN, towards better fulfilment of the RAN intent.

The term “A1 Enrichment information” refers to information utilized by near-RT RIC that is collected or derived at SMO/non-RT RIC either from non-network data sources or from network functions themselves.

The term “A1-Policy Based Traffic Steering Process Mode” refers to an operational mode in which the Near-RT RIC is configured through A1 Policy to use Traffic Steering Actions to ensure a more specific notion of network performance (for example, applying to smaller groups of E2 Nodes and UEs in the RAN) than that which it ensures in the Background Traffic Steering.

The term “Background Traffic Steering Processing Mode” refers to an operational mode in which the Near-RT RIC is configured through O1 to use Traffic Steering Actions to ensure a general background network performance which applies broadly across E2 Nodes and UEs in the RAN.

The term “Baseline RAN Behavior” refers to the default RAN behavior as configured at the E2 Nodes by SMO

The term “E2” refers to an interface connecting the Near-RT RIC and one or more O-CU-CPs, one or more O-CU-UPs, one or more O-DUs, and one or more O-eNBs.

The term “E2 Node” refers to a logical node terminating E2 interface. In this version of the specification, ORAN nodes terminating E2 interface are: for NR access: O-CU-CP, O-CU-UP, O-DU or any combination; and for E-UTRA access: O-eNB.

The term “Intents”, in the context of O-RAN systems/implementations, refers to declarative policy to steer or guide the behavior of RAN functions, allowing the RAN function to calculate the optimal result to achieve stated objective.

The term “O-RAN non-real-time RAN Intelligent Controller” or “non-RT RIC” refers to a logical function that enables non-real-time control and optimization of RAN elements and resources, AI/ML workflow including model training and updates, and policy-based guidance of applications/features in Near-RT RIC.

The term “Near-RT RIC” or “O-RAN near-real-time RAN Intelligent Controller” refers to a logical function that enables near-real-time control and optimization of RAN elements and resources via fine-grained (e.g., UE basis, Cell basis) data collection and actions over E2 interface.

The term “O-RAN Central Unit” or “O-CU” refers to a logical node hosting RRC, SDAP and PDCP protocols.

The term “O-RAN Central Unit-Control Plane” or “O-CU-CP” refers to a logical node hosting the RRC and the control plane part of the PDCP protocol.

The term “O-RAN Central Unit-User Plane” or “O-CU-UP” refers to a logical node hosting the user plane part of the PDCP protocol and the SDAP protocol

The term “O-RAN Distributed Unit” or “O-DU” refers to a logical node hosting RLC/MAC/High-PHY layers based on a lower layer functional split.

The term “O-RAN eNB” or “O-eNB” refers to an eNB or ng-eNB that supports E2 interface.

The term “O-RAN Radio Unit” or “O-RU” refers to a logical node hosting Low-PHY layer and RF processing based on a lower layer functional split. This is similar to 3GPP's “TRP” or “RRH” but more specific in including the Low-PHY layer (FFT/iFFT, PRACH extraction).

The term “01” refers to an interface between orchestration & management entities (Orchestration/NMS) and O-RAN managed elements, for operation and management, by which FCAPS management, Software management, File management and other similar functions shall be achieved.

The term “RAN UE Group” refers to an aggregations of UEs whose grouping is set in the E2 nodes through E2 procedures also based on the scope of A1 policies. These groups can then be the target of E2 CONTROL or POLICY messages.

The term “Traffic Steering Action” refers to the use of a mechanism to alter RAN behavior. Such actions include E2 procedures such as CONTROL and POLICY.

The term “Traffic Steering Inner Loop” refers to the part of the Traffic Steering processing, triggered by the arrival of periodic TS related KPM (Key Performance Measurement) from E2 Node, which includes UE grouping, setting additional data collection from the RAN, as well as selection and execution of one or more optimization actions to enforce Traffic Steering policies.

The term “Traffic Steering Outer Loop” refers to the part of the Traffic Steering processing, triggered by the near-RT RIC setting up or updating Traffic Steering aware resource optimization procedure based on information from A1 Policy setup or update, A1 Enrichment Information (EI) and/or outcome of Near-RT RIC evaluation, which includes the initial configuration (preconditions) and injection of related A1 policies, Triggering conditions for TS changes.

The term “Traffic Steering Processing Mode” refers to an operational mode in which either the RAN or the Near-RT RIC is configured to ensure a particular network performance. This performance includes such aspects as cell load and throughput, and can apply differently to different E2 nodes and UEs. Throughout this process, Traffic Steering Actions are used to fulfill the requirements of this configuration.

The term “Traffic Steering Target” refers to the intended performance result that is desired from the network, which is configured to Near-RT RIC over 01.

Furthermore, any of the disclosed embodiments and example implementations can be embodied in the form of various types of hardware, software, firmware, middleware, or combinations thereof, including in the form of control logic, and using such hardware or software in a modular or integrated manner. Additionally, any of the software components or functions described herein can be implemented as software, program code, script, instructions, etc., operable to be executed by processor circuitry. These components, functions, programs, etc., can be developed using any suitable computer language such as, for example, Python, PyTorch, NumPy, Ruby, Ruby on Rails, Scala, Smalltalk, Java™, C++, C#, “C”, Kotlin, Swift, Rust, Go (or “Golang”), EMCAScript, JavaScript, TypeScript, Jscript, ActionScript, Server-Side JavaScript (SSJS), PHP, Pearl, Lua, Torch/Lua with Just-In Time compiler (LuaJIT), Accelerated Mobile Pages Script (AMPscript), VBScript, JavaServer Pages (JSP), Active Server Pages (ASP), Node.js, ASP.NET, JAMscript, Hypertext Markup Language (HTML), extensible HTML (XHTML), Extensible Markup Language (XML), XML User Interface Language (XUL), Scalable Vector Graphics (SVG), RESTful API Modeling Language (RAML), wiki markup or Wikitext, Wireless Markup Language (WML), Java Script Object Notion (JSON), Apache® MessagePack™, Cascading Stylesheets (CSS), extensible stylesheet language (XSL), Mustache template language, Handlebars template language, Guide Template Language (GTL), Apache® Thrift, Abstract Syntax Notation One (ASN.1), Google® Protocol Buffers (protobuf), Bitcoin Script, EVM® bytecode, Solidity™, Vyper (Python derived), Bamboo, Lisp Like Language (LLL), Simplicity provided by Blockstream™, Rholang, Michelson, Counterfactual, Plasma, Plutus, Sophia, Salesforce® Apex®, and/or any other programming language or development tools including proprietary programming languages and/or development tools. The software code can be stored as a computer- or processor-executable instructions or commands on a physical non-transitory computer-readable medium. Examples of suitable media include RAM, ROM, magnetic media such as a hard-drive or a floppy disk, or an optical medium such as a compact disk (CD) or DVD (digital versatile disk), flash memory, and the like, or any combination of such storage or transmission devices.

### Abbreviations

Unless used differently herein, terms, definitions, and abbreviations may be consistent with terms, definitions, and abbreviations defined in 3GPP TR 21.905 v16.0.0 (2019-06). For the purposes of the present document, the following abbreviations may apply to the examples and embodiments discussed herein.

### Table 1 Abbreviations

| | | | | | |
|---|---|---|---|---|---|
| 3GPP | Third Generation | IBE | In-Band Emission | PUSCH | Physical Uplink Shared |
| | Partnership Project | | | | Channel |
| 4G | Fourth Generation | IEEE | Institute of Electrical | QAM | Quadrature Amplitude |
| | | | and Electronics | | Modulation |
| | | | Engineers | | |
| 5G | Fifth Generation | IEI | Information Element | QCI | QoS class of identifier |
| | | | Identifier | | |
| 5GC | 5G Core network | IEIDL | Information Element | QCL | Quasi co-location |
| | | | Identifier Data Length | | |
| AC | Application Client | IETF | Internet Engineering | QFI | QoS Flow ID, QoS |
| | | | Task Force | | Flow Identifier |
| ACK | Acknowledgement | IF | Infrastructure | QoS | Quality of Service |
| ACID | Application Client | IM | Interference | QPSK | Quadrature |
| | Identification | | Measurement, | | (Quaternary) Phase |
| | | | Intermodulation, IP | | Shift Keying |
| | | | Multimedia | | |
| AF | Application Function | IMC | IMS Credentials | QZSS | Quasi-Zenith Satellite |
| | | | | | System |
| AM | Acknowledged Mode | IMEI | International Mobile | RA-RNTI | Random Access RNTI |
| | | | Equipment Identity | | |
| AMBR | Aggregate Maximum Bit | IMGI | International mobile | RAB | Radio Access Bearer, |
| | Rate | | group identity | | Random Access Burst |
| AMF | Access and Mobility | IMPI | IP Multimedia Private | RACH | Random Access |
| | Management Function | | Identity | | Channel |
| AN | Access Network | IMPU | IP Multimedia PUblic | RADIUS | Remote Authentication |
| | | | identity | | Dial In User Service |
| ANR | Automatic Neighbour | IMS | IP Multimedia | RAN | Radio Access Network |
| | Relation | | Subsystem | | |
| AP | Application Protocol, | IMSI | International Mobile | RAND | RANDom number |
| | Antenna Port, Access | | Subscriber Identity | | (used for |
| | Point | | | | authentication) |
| API | Application Programming | IoT | Internet of Things | RAR | Random Access Response |
| | Interface | | | | |
| APN | Access Point Name | IP | Internet Protocol | RAT | Radio Access |
| | | | | | Technology |
| ARP | Allocation and Retention | Ipsec | IP Security, Internet | RAU | Routing Area Update |
| | Priority | | Protocol Security | | |
| ARQ | Automatic Repeat Request | IP-CAN | IP-Connectivity | RB | Resource block, Radio |
| | | | Access Network | | Bearer |
| AS | Access Stratum | IP-M | IP Multicast | RBG | Resource block group |
| ASP | Application Service | IPv4 | Internet Protocol | REG | Resource Element |
| | Provider | | Version 4 | | Group |
| ASN.1 | Abstract Syntax Notation | IPv6 | Internet Protocol | Rel | Release |
| | One | | Version 6 | | |
| AUSF | Authentication Server | IR | Infrared | REQ | REQuest |
| | Function | | | | |
| AWGN | Additive White Gaussian | IS | In Sync | RF | Radio Frequency |
| | Noise | | | | |
| BAP | Backhaul Adaptation | IRP | Integration Reference | RI | Rank Indicator |
| | Protocol | | Point | | |
| BCH | Broadcast Channel | ISDN | Integrated Services | RIV | Resource indicator |
| | | | Digital Network | | value |
| BER | Bit Error Ratio | ISIM | IM Services Identity | RL | Radio Link |
| | | | Module | | |
| BFD | Beam Failure Detection | ISO | International | RLC | Radio Link Control, |
| | | | Organisation for | | Radio Link Control |
| | | | Standardisation | | layer |
| BLER | Block Error Rate | ISP | Internet Service | RLC AM | RLC Acknowledged |
| | | | Provider | | Mode |
| BPSK | Binary Phase Shift Keying | IWF | Interworking-Function | RLC UM | RLC Unacknowledged |
| | | | | | Mode |
| BRAS | Broadband Remote | I-WLAN | Interworking WLAN | RLF | Radio Link Failure |
| | Access Server | | Constraint length of the | | |
| BSS | Business Support System | | convolutional code, USIM | RLM | Radio Link Monitoring |
| | | | Individual key | | |
| BS | Base Station | kB | Kilobyte (1000 bytes) | RLM-RS | Reference Signal for |
| | | | | | RLM |
| BSR | Buffer Status Report | kbps | kilo-bits per second | RM | Registration |
| | | | | | Management |
| BW | Bandwidth | Kc | Ciphering key | RMC | Reference |
| | | | | | Measurement Channel |
| BWP | Bandwidth Part | Ki | Individual subscriber | RMSI | Remaining MSI, |
| | | | authentication key | | Remaining Minimum |
| | | | | | System Information |
| C-RNTI | Cell Radio Network | KPI | Key Performance | RN | Relay Node |
| | Temporary Identity | | Indicator | | |
| CA | Carrier Aggregation, | KQI | Key Quality Indicator | RNC | Radio Network |
| | Certification Authority | | | | Controller |
| CAPEX | CAPital EXpenditure | KSI | Key Set Identifier | RNL | Radio Network Layer |
| CBRA | Contention Based Random | ksps | kilo-symbols per | RNTI | Radio Network |
| | Access | | second | | Temporary Identifier |
| CC | Component Carrier, | KVM | Kernel Virtual | ROHC | RObust Header |
| | Country Code, | | Machine | | Compression |
| | Cryptographic Checksum | | | | |
| CCA | Clear Channel Assessment | L1 | Layer 1 (physical | RRC | Radio Resource |
| | | | layer) | | Control, Radio |
| | | | | | Resource Control layer |
| CCE | Control Channel Element | L1-RSRP | Layer 1 reference | RRM | Radio Resource |
| | | | signal received power | | Management |
| CCCH | Common Control Channel | L2 | Layer 2 (data link | RS | Reference Signal |
| | | | layer) | | |
| CE | Coverage Enhancement | L3 | Layer 3 (network | RSRP | Reference Signal |
| | | | layer) | | Received Power |
| CDM | Content Delivery Network | LAA | Licensed Assisted | RSRQ | Reference Signal |
| | | | Access | | Received Quality |
| CDMA | Code-Division Multiple | LAN | Local Area Network | RSSI | Received Signal |
| | Access | | | | Strength Indicator |
| CFRA | Contention Free Random | LADN | Local Area Data | RSU | Road Side Unit |
| | Access | | Network | | |
| CG | Cell Group | LBT | Listen Before Talk | RSTD | Reference Signal Time |
| | | | | | difference |
| CGF | Charging Gateway | LCM | LifeCycle | RTP | Real Time Protocol |
| | Function | | Management | | |
| CHF | Charging Function | LCR | Low Chip Rate | RTS | Ready-To-Send |
| CI | Cell Identity | LCS | Location Services | RTT | Round Trip Time |
| CID | Cell-ID (e.g., positioning | LCID | Logical Channel ID | Rx | Reception, Receiving, |
| | method) | | | | Receiver |
| CIM | Common Information | LI | Layer Indicator | S1AP | S1 Application |
| | Model | | | | Protocol |
| CIR | Carrier to Interference | LLC | Logical Link Control, | S1-MMES1 | for the control plane |
| | Ratio | | Low Layer | | |
| | | | Compatibility | | |
| CK | Cipher Key | LPLMN | Local PLMN | S1-U | S1 for the user plane |
| CM | Connection Management, | LPP | LTE Positioning | S-GW | Serving Gateway |
| | Conditional Mandatory | | Protocol | | |
| CMAS | Commercial Mobile Alert | LSB | Least Significant Bit | S-RNTI | SRNC Radio Network |
| | Service | | | | Temporary Identity |
| CMD | Command | LTE | Long Term Evolution | S-TMSI | SAE Temporary |
| | | | | | Mobile Station |
| | | | | | Identifier |
| CMS | Cloud Management | LWA | LTE-WLAN | SA | Standalone operation |
| | System | | aggregation | | mode |
| CO | Conditional Optional | LWIP | LTE/WLAN Radio | SAE | System Architecture |
| | | | Level Integration with | | Evolution |
| | | | IPsec Tunnel | | |
| CoMP | Coordinated Multi-Point | LTE | Long Term Evolution | SAP | Service Access Point |
| CORESET | Control Resource Set | M2M | Machine-to-Machine | SAPD | Service Access Point |
| | | | | | Descriptor |
| COTS | Commercial Off-The- | MAC | Medium Access | SAPI | Service Access Point |
| | Shelf | | Control (protocol | | Identifier |
| | | | layering context) | | |
| CP | Control Plane, Cyclic | MAC | Message authentication | SCC | Secondary Component |
| | Prefix, Connection Point | | code (security/encryption | | Carrier, Secondary CC |
| | | | context) | | |
| CPD | Connection Point | MAC-A | MAC used for | SCell | Secondary Cell |
| | Descriptor | | authentication and key | | |
| | | | agreement (TSG T | | |
| | | | WG3 context) | | |
| CPE | Customer Premise | MAC-I | MAC used for data | SCEF | Service Capability |
| | Equipment | | integrity of signalling | | Exposure Function |
| | | | messages (TSG T | | |
| | | | WG3 context) | | |
| CPICH | Common Pilot Channel | MANO | Management and | SC-FDMA | Single Carrier |
| | | | Orchestration | | Frequency Division |
| | | | | | Multiple Access |
| CQI | Channel Quality Indicator | MBMS | Multimedia Broadcast | SCG | Secondary Cell Group |
| | | | and Multicast Service | | |
| CPU | CSI processing unit, | MBSFN | Multimedia Broadcast | SCM | Security Context |
| | Central Processing Unit | | multicast service | | Management |
| | | | Single Frequency | | |
| | | | Network | | |
| C/R | Command/Response field | MCC | Mobile Country Code | SCS | Subcarrier Spacing |
| | bit | | | | |
| CRAN | Cloud Radio Access | MCG | Master Cell Group | SCTP | Stream Control |
| | Network, Cloud RAN | | | | Transmission Protocol |
| CRB | Common Resource Block | MCOT | Maximum Channel | SDAP | Service Data |
| | | | Occupancy Time | | Adaptation Protocol, |
| | | | | | Service Data |
| | | | | | Adaptation Protocol |
| | | | | | layer |
| CRC | Cyclic Redundancy Check | MCS | Modulation and coding | SDL | Supplementary |
| | | | scheme | | Downlink |
| CRI | Channel-State Information | MDAF | Management Data | SDNF | Structured Data |
| | Resource Indicator, CSI- | | Analytics Function | | Storage Network |
| | RS Resource Indicator | | | | Function |
| C-RNTI | Cell RNTI | MDAS | Management Data | SDP | Session Description |
| | | | Analytics Service | | Protocol |
| CS | Circuit Switched | MDT | Minimization of Drive | SDSF | Structured Data |
| | | | Tests | | Storage Function |
| CSAR | Cloud Service Archive | ME | Mobile Equipment | SDU | Service Data Unit |
| CSI | Channel-State Information | MeNB | master eNB | SEAF | Security Anchor |
| | | | | | Function |
| CSI-IM | CSI Interference | MER | Message Error Ratio | SeNB | secondary eNB |
| | Measurement | | | | |
| CSI-RS | CSI Reference Signal | MGL | Measurement Gap | SEPP | Security Edge |
| | | | Length | | Protection Proxy |
| CSI-RSRP | CSI reference signal | MGRP | Measurement Gap | SFI | Slot format indication |
| | received power | | Repetition Period | | |
| CSI-RSRQ | CSI reference signal | MIB | Master Information | SFTD | Space-Frequency Time |
| | received quality | | Block, Management | | Diversity, SFN and |
| | | | Information Base | | frame timing difference |
| CSI-SINR | CSI signal-to-noise and | MIMO | Multiple Input | SFN | System Frame Number |
| | interference ratio | | Multiple Output | | |
| CSMA | Carrier Sense Multiple | MLC | Mobile Location | SgNB | Secondary gNB |
| | Access | | Centre | | |
| CSMA/CA | CSMA with collision | MM | Mobility Management | SGSN | Serving GPRS Support |
| | avoidance | | | | Node |
| CSS | Common Search Space, | MME | Mobility Management | S-GW | Serving Gateway |
| | Cell-specific Search Space | | Entity | | |
| CTF | Charging Trigger Function | MN | Master Node | SI | System Information |
| CTS | Clear-to-Send | MNO | Mobile Network | SI-RNTI | System Information |
| | | | Operator | | RNTI |
| CW | Codeword | MO | Measurement Object, | SIB | System Information |
| | | | Mobile Originated | | Block |
| CWS | Contention Window Size | MPBCH | MTC Physical | SIM | Subscriber Identity |
| | | | Broadcast CHannel | | Module |
| D2D | Device-to-Device | MPDCCH | MTC Physical | SIP | Session Initiated |
| | | | Downlink Control | | Protocol |
| | | | CHannel | | |
| DC | Dual Connectivity, Direct | MPDSCH | MTC Physical | SiP | System in Package |
| | Current | | Downlink Shared | | |
| | | | CHannel | | |
| DCI | Downlink Control | MPRACH | MTC Physical | SL | Sidelink |
| | Information | | Random Access | | |
| | | | CHannel | | |
| DF | Deployment Flavour | MPUSCH | MTC Physical Uplink | SLA | Service Level |
| | | | Shared Channel | | Agreement |
| DL | Downlink | MPLS | MultiProtocol Label | SM | Session Management |
| | | | Switching | | |
| DMTF | Distributed Management | MS | Mobile Station | SMF | Session Management |
| | Task Force | | | | Function |
| DPDK | Data Plane Development | MSB | Most Significant Bit | SMS | Short Message Service |
| | Kit | | | | |
| DM-RS, DMRS | Demodulation | MSC | Mobile Switching | SMSF | SMS Function |
| | Reference Signal | | Centre | | |
| DN | Data network | MSI | Minimum System | SMTC | SSB-based |
| | | | Information, MCH | | Measurement Timing |
| | | | Scheduling | | Configuration |
| | | | Information | | |
| DNN | Data Network Name | MSID | Mobile Station | SN | Secondary Node, |
| | | | Identifier | | Sequence Number |
| DNAI | Data Network Access | MSIN | Mobile Station | SoC | System on Chip |
| | Identifier | | Identification Number | | |
| DRB | Data Radio Bearer | MSISDN | Mobile Subscriber | SON | Self-Organizing |
| | | | ISDN Number | | Network |
| DRS | Discovery Reference | MT | Mobile Terminated, | SpCell | Special Cell |
| | Signal | | Mobile Termination | | |
| DRX | Discontinuous Reception | MTC | Machine-Type | SP-CSI-RNTI | Semi-Persistent |
| | | | Communications | | CSI RNTI |
| DSL | Domain Specific | mMTC | massive MTC, massive | SPS | Semi-Persistent |
| | Language. Digital | | Machine-Type | | Scheduling |
| | Subscriber Line | | Communications | | |
| DSLAM | DSL Access Multiplexer | MU-MIMO | Multi User MIMO | SQN | Sequence number |
| DwPTS | Downlink Pilot Time Slot | MWUS | MTC wake-up signal, | SR | Scheduling Request |
| | | | MTC WUS | | |
| E-LAN | Ethernet Local Area | NACK | Negative | SRB | Signalling Radio |
| | Network | | Acknowledgement | | Bearer |
| E2E | End-to-End | NAI | Network Access | SRS | Sounding Reference |
| | | | Identifier | | Signal |
| ECCA | extended clear channel | NAS | Non-Access Stratum, | SS | Synchronization Signal |
| | assessment, extended | | Non-Access Stratum | | |
| | CCA | | layer | | |
| ECCE | Enhanced Control | NCT | Network Connectivity | SSB | Synchronization Signal |
| | Channel Element, | | Topology | | Block |
| | Enhanced CCE | | | | |
| ED | Energy Detection | NC-JT | Non-Coherent Joint | SSID | Service Set Identifier |
| | | | Transmission | | |
| EDGE | Enhanced Datarates for | NEC | Network Capability | SS/PBCH | Block |
| | GSM Evolution (GSM | | Exposure | | |
| | Evolution) | | | | |
| EAS | Edge Application Server | NE-DC | NR-E-UTRA Dual | SSBRI | SS/PBCH Block |
| | | | Connectivity | | Resource Indicator, |
| | | | | | Synchronization Signal |
| | | | | | Block Resource |
| | | | | | Indicator |
| EASID | Edge Application Server | NEF | Network Exposure | SSC | Session and Service |
| | Identification | | Function | | Continuity |
| ECS | Edge Configuration Server | NF | Network Function | SS-RSRP | Synchronization Signal |
| | | | | | based Reference Signal |
| | | | | | Received Power |
| ECSP | Edge Computing Service | NFP | Network Forwarding | SS-RSRQ | Synchronization Signal |
| | Provider | | Path | | based Reference Signal |
| | | | | | Received Quality |
| EDN | Edge Data Network | NFPD | Network Forwarding | SS-SINR | Synchronization Signal |
| | | | Path Descriptor | | based Signal to Noise |
| | | | | | and Interference Ratio |
| EEC | Edge Enabler Client | NFV | Network Functions | SSS | Secondary |
| | | | Virtualization | | Synchronization Signal |
| EECID | Edge Enabler Client | NFVI | NFV Infrastructure | SSSG | Search Space Set |
| | Identification | | | | Group |
| EES | Edge Enabler Server | NFVO | NFV Orchestrator | SSSIF | Search Space Set |
| | | | | | Indicator |
| EESID | Edge Enabler Server | NG | Next Generation, Next | SST | Slice/Service Types |
| | Identification | | Gen | | |
| EHE | Edge Hosting | NGEN-DC | NG-RAN E-UTRA- | SU-MIMO | Single User MIMO |
| | Environment | | NR Dual Connectivity | | |
| EGMF | Exposure Governance | NM | Network Manager | SUL | Supplementary Uplink |
| | tableManagement | | | | |
| | Function | | | | |
| EGPRS | Enhanced GPRS | NMS | Network Management | TA | Timing Advance, |
| | | | System | | Tracking Area |
| EIR | Equipment Identity | N-PoP | Network Point of | TAC | Tracking Area Code |
| | Register | | Presence | | |
| eLAA | enhanced Licensed | NMIB, N-MIB | Narrowband MIB | TAG | Timing Advance Group |
| | Assisted Access, enhanced | | | | |
| | LAA | | | | |
| EM | Element Manager | NPBCH | Narrowband Physical | TAI | Tracking Area Identity |
| | | | Broadcast CHannel | | |
| eMBB | Enhanced Mobile | NPDCCH | Narrowband Physical | TAU | Tracking Area Update |
| | Broadband | | Downlink Control | | |
| | | | CHannel | | |
| EMS | Element Management | NPDSCH | Narrowband Physical | TB | Transport Block |
| | System | | Downlink Shared | | |
| | | | CHannel | | |
| eNB | evolved NodeB, E- | NPRACH | Narrowband Physical | TBS | Transport Block Size |
| | UTRAN Node B | | Random Access | | |
| | | | CHannel | | |
| EN-DC | E-UTRA-NR Dual | NPUSCH | Narrowband Physical | TBD | To Be Defined |
| | Connectivity | | Uplink Shared | | |
| | | | CHannel | | |
| EPC | Evolved Packet Core | NPSS | Narrowband Primary | TCI | Transmission |
| | | | Synchronization Signal | | Configuration Indicator |
| EPDCCH | enhanced PDCCH, | NSSS | Narrowband | TCP | Transmission |
| | enhanced Physical | | Secondary | | Communication |
| | Downlink Control Cannel | | Synchronization Signal | | Protocol |
| EPRE | Energy per resource | NR | New Radio, Neighbour | TDD | Time Division Duplex |
| | element | | Relation | | |
| EPS | Evolved Packet System | NRF | NF Repository | TDM | Time Division |
| | | | Function | | Multiplexing |
| EREG | enhanced REG, enhanced | NRS | Narrowband Reference | TDMA | Time Division Multiple |
| | resource element groups | | Signal | | Access |
| ETSI | European | NS | Network Service | TE | Terminal Equipment |
| | Telecommunications | | | | |
| | Standards Institute | | | | |
| ETWS | Earthquake and Tsunami | NSA | Non-Standalone | TEID | Tunnel End Point |
| | Warning System | | operation mode | | Identifier |
| eUICC | embedded UICC, | NSD | Network Service | TFT | Traffic Flow Template |
| | embedded Universal | | Descriptor | | |
| | Integrated Circuit Card | | | | |
| E-UTRA | Evolved UTRA | NSR | Network Service | TMSI | Temporary Mobile |
| | | | Record | | Subscriber Identity |
| E-UTRAN | Evolved UTRAN | NSSAI | Network Slice | TNL | Transport Network |
| | | | Selection Assistance | | Layer |
| | | | Information | | |
| EV2X | Enhanced V2X | S-NNSAI | Single-NSSAI | TPC | Transmit Power |
| | | | | | Control |
| F1AP | F1 Application Protocol | NSSF | Network Slice | | |
| | | | Selection Function | TPMI | Transmitted Precoding |
| | | | | | Maxtrix Indicator |
| F1-C | F1 Control plane interface | NW | Network | TR | Technical Report |
| F1-U | F1 User plane interface | NWUS | Narrowband wake-up | TRP, TRxP | Transmission |
| | | | signal, Narrowband | | Reception Point |
| | | | WUS | | |
| FACCH | Fast Associated Control | NZP | Non-Zero Power | TRS | Tracking Reference |
| | CHannel | | | | Signal |
| FACCH/F | Fast Associated Control | O&M | Operation and | TRx | Transceiver |
| | Channel/Full rate | | Maintenance | | |
| FACCH/H | Fast Associated Control | ODU2 | Optical channel Data | TS | Technical |
| | Channel/Half rate | | Unit - type 2 | | Specifications, |
| | | | | | Technical Standard |
| FACH | Forward Access Channel | OFDM | Orthogonal Frequency | TTI | Transmission Time |
| | | | Division Multiplexing | | Interval |
| FAUSCH | Fast Uplink Signalling | OFDMA | Orthogonal Frequency | Tx | Transmission, |
| | Channel | | Division Multiple | | Transmitting, |
| | | | Access | | Transmitter |
| FB | Functional Block | OOB | Out-of-band | U-RNTI | UTRAN Radio |
| | | | | | Network Temporary |
| | | | | | Identity |
| FBI | Feedback Information | OOS | Out of Sync | UART | Universal |
| | | | | | Asynchronous |
| | | | | | Receiver and |
| | | | | | Transmitter |
| FCC | Federal Communications | OPEX | OPerating EXpense | UCI | Uplink Control |
| | Commission | | | | Information |
| FCCH | Frequency Correction | OSI | Other System | UE | User Equipment |
| | CHannel | | Information | | |
| FDD | Frequency Division | OSS | Operations Support | UDM | Unified Data |
| | Duplex | | System | | Management |
| FDM | Frequency Division | OTA | over-the-air | UDP | User Datagram |
| | Multiplex | | | | Protocol |
| FDMA | Frequency Division | PAPR | Peak-to-Average | UDSF | Unstructured Data |
| | Multiple Access | | Power Ratio | | Storage Network |
| | | | | | Function |
| FE | Front End | PAR | Peak to Average Ratio | UICC | Universal Integerated |
| | | | | | Circuit Card |
| FEC | Forward Error Correction | PBCH | Physical Broadcast | UL | Uplink |
| | | | Channel | | |
| FFS | For Further Study | PC | Power Control, | UM | Unacknowledged |
| | | | Personal Computer | | Mode |
| FFT | Fast Fourier | PCC | Primary Component | UML | Unified Modelling |
| | Transformation | | Carrier, Primary CC | | Language |
| feLAA | further enhanced Licensed | PCell | Primary Cell | UMTS | Universal Mobile |
| | Assisted Access, further | | | | Telecommunications |
| | enhanced LAA | | | | System |
| FN | Frame Number | PCI | Physical Cell ID, | UP | User Plane |
| | | | Physical Cell Identity | | |
| FPGA | Field-Programmable Gate | PCEF | Policy and Charging | UPF | User Plane Function |
| | Array | | Enforcement Function | | |
| FR | Frequency Range | PCF | Policy Control | URI | Uniform Resource |
| | | | Function | | Identifier |
| FQDN | Fully Qualified Domain | PCRF | Policy Control and | URL | Uniform Resource |
| | Name | | Charging Rules | | Locator |
| | | | Function | | |
| G-RNTI | GERAN Radio Network | PDCP | Packet Data | URLLC | Ultra-Reliable and Low |
| | Temporary Identity | | Convergence Protocol, | | Latency |
| | | | Packet Data | | |
| | | | Convergence Protocol | | |
| | | | layer | | |
| GERAN | GSM EDGE RAN, GSM | PDCCH | Physical Downlink | USB | Universal Serial Bus |
| | EDGE Radio Access | | Control Channel | | |
| | Network | | | | |
| GGSN | Gateway GPRS Support | PDCP | Packet Data | USIM | Universal Subscriber |
| | Node | | Convergence Protocol | | Identity Module |
| GLONASS | GLObal'naya | PDN | Packet Data Network, | USS | UE-specific search |
| | NAvigatsionnaya | | Public Data Network | | space |
| | Sputnikovaya Sistema | | | | |
| | (Engl.: Global Navigation | | | | |
| | Satellite System) | | | | |
| gNB | Next Generation NodeB | PDSCH | Physical Downlink | UTRA | UMTS Terrestrial |
| | | | Shared Channel | | Radio Access |
| gNB-CU | gNB-centralized unit, Next | PDU | Protocol Data Unit | UTRAN | Universal Terrestrial |
| | Generation NodeB | | | | |
| | centralized unit | | | | Radio Access Network |
| gNB-DU | gNB-distributed unit, Next | PEI | Permanent Equipment | UwPTS | Uplink Pilot Time Slot |
| | Generation NodeB | | Identifiers | | |
| | distributed unit | | | | |
| GNSS | Global Navigation | PFD | Packet Flow | V2I | Vehicle-to- |
| | Satellite System | | Description | | Infrastruction |
| GPRS | General Packet Radio | P-GW | PDN Gateway | V2P | Vehicle-to-Pedestrian |
| | Service | | | | |
| GPSI | Generic Public | PHICH | Physical hybrid-ARQ | V2V | Vehicle-to-Vehicle |
| | Subscription Identifier | | indicator channel | | |
| GSM | Global System for Mobile | PHY | Physical layer | V2X | Vehicle-to-everything |
| | Communications, Groupe | | | | |
| | Spécial Mobile | | | | |
| GTP | GPRS Tunneling Protocol | PLMN | Public Land Mobile | VIM | Virtualized |
| | | | Network | | Infrastructure Manager |
| GTP-U | GPRS Tunnelling Protocol | PIN | Personal Identification | VL | Virtual Link, |
| | for User Plane | | Number | | |
| GTS | Go To Sleep Signal | PM | Performance | VLAN | Virtual LAN, Virtual |
| | (related to WUS) | | Measurement | | Local Area Network |
| GUMMEI | Globally Unique MME | PMI | Precoding Matrix | VM | Virtual Machine |
| | Identifier | | Indicator | | |
| GUTI | Globally Unique | PNF | Physical Network | VNF | Virtualized Network |
| | Temporary UE Identity | | Function | | Function |
| HARQ | Hybrid ARQ, Hybrid | PNFD | Physical Network | VNFFG | VNF Forwarding |
| | Automatic Repeat Request | | Function Descriptor | | Graph |
| HANDO | Handover | PNFR | Physical Network | VNFFGD | VNF Forwarding |
| | | | Function Record | | Graph Descriptor |
| HFN | HyperFrame Number | POC | PTT over Cellular | VNFM | VNF Manager |
| HHO | Hard Handover | PP, PTP | Point-to-Point | VoIP | Voice-over-IP, Voice- |
| | | | | | over-Internet Protocol |
| HLR | Home Location Register | PPP | Point-to-Point Protocol | VPLMN | Visited Public Land |
| | | | | | Mobile Network |
| HN | Home Network | PRACH | Physical RACH | VPN | Virtual Private |
| | | | | | Network |
| HO | Handover | PRB | Physical resource | VRB | Virtual Resource Block |
| | | | block | | |
| HPLMN | Home Public Land Mobile | PRG | Physical resource | WiMAX | Worldwide |
| | Network | | block group | | Interoperability for |
| | | | | | Microwave Access |
| HSDPA | High Speed Downlink | ProSe | Proximity Services, | WLAN | Wireless Local Area |
| | Packet Access | | Proximity-Based | | Network |
| | | | Service | | |
| HSN | Hopping Sequence | PRS | Positioning Reference | WMAN | Wireless Metropolitan |
| | Number | | Signal | | Area Network |
| HSPA | High Speed Packet Access | PRR | Packet Reception | WPAN | Wireless Personal Area |
| | | | Radio | | Network |
| HSS | Home Subscriber Server | PS | Packet Services | X2-C | X2-Control plane |
| HSUPA | High Speed Uplink Packet | PSBCH | Physical Sidelink | X2-U | X2-User plane |
| | Access | | Broadcast Channel | | |
| HTTP | Hyper Text Transfer | PSDCH | Physical Sidelink | XML | eXtensible Markup |
| | Protocol | | Downlink Channel | | Language |
| HTTPS | Hyper Text Transfer | PSCCH | Physical Sidelink | XRES | EXpected user |
| | Protocol Secure (https is | | Control Channel | | RESponse |
| | http/1.1 over SSL, i.e. port | | | | |
| | 443) | | | | |
| I-Block | Information Block | PSSCH | Physical Sidelink | XOR | eXclusive OR |
| | | | Shared Channel | | |
| ICCID | Integrated Circuit Card | PSCell | Primary SCell | ZC | Zadoff-Chu |
| | Identification | | | | |
| IAB | Integrated Access and | PSS | Primary | ZP | Zero Po |
| | Backhaul | | Synchronization Signal | | |
| ICIC | Inter-Cell Interference | PSTN | Public Switched | | |
| | Coordination | | Telephone Network | | |
| ID | Identity, identifier | PT-RS | Phase-tracking | | |
| | | | reference signal | | |
| IDFT | Inverse Discrete Fourier | PTT | Push-to-Talk | | |
| | Transform | | | | |
| IE | Information element | PUCCH | Physical Uplink | | |
| | | | Control Channel | | |

The foregoing description provides illustration and description of various example embodiments, but is not intended to be exhaustive or to limit the scope of embodiments to the precise forms disclosed. Modifications and variations are possible in light of the above teachings or may be acquired from practice of various embodiments. Where specific details are set forth in order to describe example embodiments of the disclosure, it should be apparent to one skilled in the art that the disclosure can be practiced without, or with variation of, these specific details. It should be understood, however, that there is no intent to limit the concepts of the present disclosure to the particular forms disclosed, but on the contrary, the intention is to cover all modifications, equivalents, and alternatives consistent with the present disclosure and the appended claims.

What is claimed is:

1. A device for a session management function (SMF) for managing traffic in a 5G system (5GS), the SMF comprising processing circuitry configured to:
a processing circuitry configured to:
receive a Policy Control and Charging (PCC) rule from a Policy Control Function (PCF), which includes an identifier (ID) for a standardized traffic pattern (STP) and a machine learning model identifier (ML model ID) of an ML model to be used for traffic detection; and
send a Packet Detection Rule (PDR) to a User Plane Function (UPF) that includes an STP ID and the ML model ID to initiate an ML based detection of the STP; and
a memory to store the PCC rule.

2. The device of claim 1, wherein the processing circuitry is further configured to transmit a packet detection rule (PDR) to the UPF including the STP ID and ML model ID.

3. The device of claim 2, wherein the processing circuitry is further configured to transmit a forwarding action rule (FAR) to steer the traffic detected by the PDR to a quality-of-service flow.

4. The device of claim 1, wherein the processing circuitry is further configured to transmit a non-access stratum message to the UE including the STP ID and ML model ID.

5. The device of claim 4, wherein the non-access stratum message further comprises a uniform resource locator of the ML model.

6. The device of claim 1, wherein the processing circuitry is further configured to subscribe to analytics from network data analytics function (NWDAF) model training logical function (MTLF).

7. The device of claim 6, wherein the NWDAF MTLF provides a trained ML model to NWDAF AnLF identified by an ML model identifier.

8. The device of claim 6, wherein the trained ML model in NWDAF AnLF provides STP analytics when requested by a service consumer to detect a specific STP.

9. The device of claim 1, wherein the processing circuitry is further configured to mark downlink packets with a reflective quality of service (QoS) indicator.

10. The device of claim 8, wherein the reflective QoS indicator enables the UE to derive a QoS rule for uplink traffic upon receiving the downlink packets.

11. The device of claim 9, wherein the QoS rule comprises a wildcard for port values in a packet filter.

12. A method for Machine Learning (ML) based traffic detection in a 5G System (5GS), comprising:
receiving a Policy Control and Charging (PCC) rule at a Session Management Function (SMF) from a Policy Control Function (PCF);
processing the PCC rule to include identifiers for both a Standardized Traffic Profile (STP) and an ML model;
instructing User Equipment (UE) via an N1 reference point to initiate detection of the STP using the identified ML model.

13. The method of claim 12, wherein the PCF initiates detection of the STP by forwarding the PCC rule to the SMF, which includes the STP identifier (ID) and the ML model ID for the traffic detection.

14. The method of claim 13, wherein the STP ID in the PCC rule is subsumed under the Application ID in the PCC rule communicated via a N7 reference point.

15. The method of claim 12, wherein the UE fetches the indicated ML model from an application server in the data network that acts as an ML model repository.

16. The method of claim 12, whereby upon successful detection of the STP, the UE directs the uplink packets of this STP to a pre-established Quality of Service (QoS) Flow.

17. The method of claim 16, where the direction of uplink packets is guided by a QoS Flow Identifier (QFI) as detailed in the QoS rule.

18. The method of claim 15, wherein the application server updates the ML model based on feedback received from the UEs about the detection efficacy, and the updated ML model is automatically downloaded by the UE.

19. (canceled)

20. (canceled)

21. A non-transitory computer-readable medium storing computer-executable instructions which when executed by one or more processors for a session management function (SMF) for managing traffic in a 5G system (5GS), result in performing operations comprising:
receive a Policy Control and Charging (PCC) rule from a Policy Control Function (PCF), which includes an identifier (ID) for a standardized traffic pattern (STP) and a machine learning model identifier (ML model ID) of an ML model to be used for traffic detection; and
send a Packet Detection Rule (PDR) to a User Plane Function (UPF) that includes an STP ID and the ML model ID to initiate an ML based detection of the STP.

22. The non-transitory computer-readable medium of claim 21, wherein the operations further comprise transmit a packet detection rule (PDR) to the UPF including the STP ID and ML model ID.
